(19) United States
(12) Patent Application Publication
(10) Pub. No.: US 2023/0407743 A1
(43) Pub. Date: Dec. 21, 2023

(54) INFINITE-ACTING AND INFINITE-SUPPLY MICROMODEL SYSTEMS

(71) Applicants: UNIVERSITY OF WYOMING, Laramie, WY (US); Alchemy Sciences, Inc., Houston, TX (US)

(72) Inventors: Aktham Ehab SHOUKRY, Laramie, WY (US); Mohammad PIRI, Laramie, WY (US); Shashidhar RAJAGOPALAN, Houston, TX (US); Soheil SARAJI, Laramie, WY (US)

(21) Appl. No.: 18/209,588

(22) Filed: Jun. 14, 2023

Related U.S. Application Data
(60) Provisional application No. 63/352,603, filed on Jun. 15, 2022.

(51) Int. Cl. E21B 49/00

(52) U.S. Cl. CPC E21B 49/00

(57) ABSTRACT

Embodiments of the present disclosure generally relate to systems, devices, and methods to model fluid flow in a porous medium. In an embodiment, a microfluidic device to model subterranean fluid flow is disclosed. The device includes a mold of solid material, the mold including a field of pores and throats formed in the mold for mimicking a porous rock formation, a peripheral channel formed in the mold for mimicking a fluid reservoir, and an interior channel formed in the mold for mimicking a well. The peripheral channel can trace a perimeter or circumference of the field of pores and throats and be in fluid communication with the pores and throats.

### CROSS-REFERENCES TO RELATED APPLICATIONS

This application claims benefit of and priority to U.S. Provisional Patent Application Ser. No. 63/352,603, filed on Jun. 15, 2022, which is incorporated herein by reference in its entirety.

### BACKGROUND

### Field

Embodiments of the present disclosure generally relate to microfluidic systems, devices, and methods to model fluid flow in a porous medium.

### Description of the Related Art

Natural hydrocarbon reservoirs are typically found in rock formations exhibiting a complex pore-structure. In such porous media, imbibition or seepage of fluids into the surrounding rock formation occurs in hydraulic-fracturing processes. This imbibition can reduce the hydrocarbon permeability significantly, thus reducing the well productivity. Many factors have an effect on the imbibition mechanism including fracturing fluid composition, well configuration and shape, and boundary conditions regarding pressure and flow rate. Controlling imbibition serves to enhance the well's productivity. Micromodels can be useful tools for visualizing the imbibition mechanism and dynamics, screening for optimal conditions for a given fracturing site, and collecting data for computational simulations, among other applications. However, conventional micromodels are unable to accurately reproduce the complexity of the reservoir boundary conditions as well as different well configurations. For example, conventional micromodels are only able to represent a single well/channel. As a result, the effect of nearby wells during flow-back cannot be reproduced. Furthermore, the boundary conditions of conventional micromodels do not accurately represent real world conditions.

Therefore, there is a need for new and improved microfluidic systems, devices, and methods for modeling fluid flow in a porous.

### SUMMARY

Provided herein are microfluidic systems, devices, and methods to model fluid flow in a porous medium. Microfluidic systems, devices, and methods of the present disclosure can be useful, for example, to model subterranean fluid flow in, for example, a porous medium as well as in fractured wells embedded within. For example, and in some embodiments, microfluidic systems, devices, and methods disclosed herein can be used to model the flow of hydrocarbon fluids, gases, water, among others in the underground porous reservoir formations.

In an embodiment, a microfluidic device is provided. The microfluidic device includes a mold of solid material, a first fluid port disposed in the microfluidic device, and a second fluid port disposed in the microfluidic device. The mold comprises: a field of pores and throats formed in the mold, the pores are interconnected via the throats and the pores have a larger cross-sectional area than the throats; a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats; an interior channel formed in the mold, the interior channel at least partially traversing the field of pores and throats, the interior channel having a larger cross-sectional area than the pores and the throats; and a side channel formed in the mold, the side channel branching off from the interior channel into the field of pores and throats, the side channel in fluid communication with the pores and throats. The first fluid port is in direct fluid communication with a first end of the interior channel. The second fluid port is in direct fluid communication with one end of the peripheral channel. The interior channel can be in indirect fluid communication with the pores and throats.

In another embodiment, a microfluidic device to model subterranean fluid flow is provided. The microfluidic device includes a mold of solid material, a first fluid port disposed in the microfluidic device, and a second fluid port disposed in the microfluidic device. The mold comprises a field of pores and throats formed in the mold, the pores are interconnected via the throats and the pores have a larger cross-sectional area than the throats; a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats; a plurality of interior channels formed in the mold, the plurality of interior channels at least partially traversing the field of pores and throats, the plurality of interior channels are in indirect fluid communication with the pores and throats, each interior channel of the plurality of interior channels having a larger cross-sectional area than the pores and the throats; and at least one interior channel of the plurality of interior channels coupled to a side channel through which the at least one interior channel communicates with the field of pores and throats of the field. The first fluid port is in direct fluid communication with a first end of the interior channel. The second fluid port is in direct fluid communication with one end of the peripheral channel.

In another embodiment, a method of mimicking or simulating fluid flow in a subterranean fluid system is provided. The method includes supplying a reservoir fluid to at least 50% of a perimeter or circumference of a field of pores and throats formed in a microfluidic device. The method further includes flowing a target fluid through an interior channel formed in the microfluidic device, the interior channel at least partially traversing the field of pores and throats, the interior channel in fluid communication with the pores and throats.

In another embodiment, a microfluidic device to model subterranean fluid flow includes a mold of solid material, a first fluid port disposed in the device and a second fluid port disposed in the device. The mold includes a field of pores and throats formed in the mold mimicking porous rock formation. The pores formed in the mold are interconnected via the throats. The pores may have a larger cross-sectional area than the throats. The mold includes a peripheral channel formed in the mold for mimicking reservoir boundary conditions, and an interior channel formed in the mold for mimicking a well. The peripheral channel may trace a majority of a perimeter of the field of pores and throats. The peripheral channel allows fluid communication with the pores and throats. The peripheral channel may have a larger cross-sectional area than the pores and the throats. The interior channel formed in the mold may at least partially traverse the field of pores and throats. The interior channel may be in fluid communication with the pores and throats. The interior channel may have a larger cross-sectional area than the pores and the throats. The first fluid port may be in direct fluid communication with one end of the interior channel. The second fluid port may be in direct fluid communication with one end of the peripheral channel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A and 1B show a schematic representation of a well (vertical and horizontal) drilled in a hydrocarbon reservoir peripherally surrounded by an infinite aquifer in a porous rock formation.

FIG. 1C shows a schematic representation of a layout of a water-aquifer drive.

FIGS. 2A-2C show a schematic representation of fractured vertical and horizontal wells, with the top views in each case.

FIG. 3 shows a schematic representation of a fractured horizontal well with an area of microfractures surrounding the hydraulically-fractured zone.

FIGS. 4A and 4B show two examples of conventional micromodels that relate to studying infinite-acting reservoirs and fractured wells.

FIG. 4C shows two examples of conventional micromodels that relate to studying naturally, not hydraulically, fractured reservoirs.

FIG. 5 shows an example of a micromodel according to at least one embodiment of the present disclosure.

FIG. 6 shows an example of a micromodel that includes two interior channels according to at least one embodiment of the present disclosure.

FIG. 7 shows an example of a micromodel that includes a circular field of pores and throats according to at least one embodiment of the present disclosure.

FIG. 8 shows an example of a micromodel that includes a second field of pores and throats (“microfractures”) according to at least one embodiment of the present disclosure.

FIG. 9 shows an example design configuration of a micromodel with selected, but non-limiting, dimensions used for a conducted study according to at least one embodiment of the present disclosure.

FIG. 10 shows additional details and dimensions of a micromodel used for a conducted study according to at least one embodiment of the present disclosure.

FIG. 11 shows a schematic diagram showing selected operations of an imbibition (flow-back) study according to at least one embodiment of the present disclosure.

FIG. 12 shows results of a comparison of injection of surfactant versus water after drainage (left panel) and after imbibition (right panel) according to at least one embodiment of the present disclosure.

FIG. 13 shows data for the final saturation for the comparison of water and surfactant in FIG. 12 according to at least one embodiment of the present disclosure.

FIG. 14 shows data for the flow-back efficiency for the comparison of water and surfactant in FIG. 12 according to at least one embodiment of the present disclosure

FIG. 15 is a photograph showing a side perspective view of an example micromodel according to at least one embodiment of the present disclosure.

FIG. 16 is a photograph showing a top view of an example micromodel according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to microfluidic systems, devices, and methods to model fluid flow in a porous medium. The inventors have found new and improved micromodel systems and devices (for example, layouts and configurations) as well as methods that overcome the deficiencies of conventional technologies. For example, embodiments described herein more accurately reproduce reservoir boundary conditions and different well configurations, among other parameters. Further, embodiments, described herein can be utilized to represent multiple wells and channels. As a result, embodiments of the present disclosure reflect real-world conditions present at aquifers and reservoirs. The disclosed systems, devices, and methods can more closely simulate actual petroleum-reservoir conditions in micromodels. For example, the disclosed matrix of throats and pores can more closely represent those of actual porous rock formation. Additionally or alternatively, the disclosed systems, devices, and methods can more closely represent real world boundary conditions in porous rock systems. Overall, microfluidic systems, devices, and methods described herein more closely simulate and/or mimic hydrocarbon containing reservoir conditions.

Micromodels (microfluidic devices) are generally quasi-two-dimensional representations of porous media that are used to directly visualize pore-scale fluid flow. Pore-scale observations using micromodels are used to, for example, understand oil-water interactions, solid-fluid interactions, the dynamics and mechanisms of imbibition, surfactant screening, fluid flow behavior, among other applications. Such understanding at the microscopic level can provide insights into real-world conditions (macroscopic, or field-scale, level).

As described above, conventional technologies may not be representative of real-world conditions and applications. As a result, the understandings and results gathered by use of conventional micromodels cannot be utilized/upscaled effectively in the field during primary, secondary, and/or enhanced oil recovery. In contrast, embodiments described herein can enable significantly improved understandings applicable to the field, thereby enabling an improved transition from pore to field scale. Embodiments described herein can enable an improved understanding of the pore-scale interplays of the imbibition process and wells interactions with the formation as well as with themselves. Such improved understanding can enable, for example, improved hydraulic fracturing processes among other oil recovery processes.

In contrast to conventional technologies, microfluidic devices (micromodels) and methods can enable investigation of the behavior of a fractured horizontal well in a microfluidic layout that is objectively closer to the actual (real-field) layout in terms of, for example, well shape and reservoir boundaries. Different boundary conditions (constant pressure or constant rate) as well as variable well fractures' shapes and dimensions can, therefore, be probed and correlated with the physical fluid displacement events seen in the micromodel device under the microscope. Different operations, such as injection strategies, production strategies, injected chemicals, production schedules, or combinations thereof, among others can also be investigated.

Further, embodiments described herein can integrate multiple horizontal fractured wells into the same microfluidic device. The interference between wells can, therefore, be examined where different operations (for example, injection strategies, production strategies, injected chemicals, production schedules, combinations thereof, among others) may be applied among these wells. The design geometry of each well (interior channel) can be independent of the other well (interior channel) which can enable exploration of different designs.

Further, embodiments described herein include a peripheral channel which can provide the ability of continuously supplying fluids into the exterior of the matrix of pores/throats, resembling a real field aquifer. Also, the inclusion of an (or multiple) interior channel(s), with side channels branching off mimicking hydraulic fractures, results in more realistic and practical studies of a simulated horizontal well behavior or wells interference. This has not been, and cannot be, done using conventional micromodel designs.

Micromodels described herein can be, or form, a portion of a microfluidic device. The micromodels (or microfluidic devices thereof) can be used to model subterranean fluid flow.

In general, the terms and phrases used herein have their art-recognized meaning, which can be found by reference to standard texts, journal references and contexts known to those skilled in the art. The following definitions are provided to clarify their specific use in the context of the present disclosure.

For purposes of the present disclosure, and unless the context indicates otherwise, the terms “mimic” and “mimicking” are used interchangeably with the terms “simulate” and “simulating”. For example, the term “mimic” includes both “mimic” and “simulate”.

For purposes of the present disclosure, the term “throat” refers to a constriction within a porous material that connects two or more pores, the pores having a larger cross-sectional area than the throats, wherein the cross-sectional area is measured perpendicular to the direction of flow. Thus, the number, size and distribution of the pore throats control, for example, the pressure drop, flow and capillary-pressure characteristics of the porous micromodel. The cross section of the throat can take any shape (rectangular, circular, among others). In some embodiments, a throat can comprise narrow channels of constant cross-sectional area. In “2 dimensional” micromodels, (i.e., micromodels in which the pores, throats, and other channels do not vary in the z dimension), the cross section of a throat perpendicular to the direction of flow may be rectangular in shape. There are also “2.5-dimensional micromodels where the z-dimension of the throat can be smaller than that of the pore.

Micromodels of the present disclosure can be 2-dimensional or 2.5-dimensional, though other dimensions are contemplated.

For purposes of the present disclosure, the term “pore” refers to a void in a porous material that acts as a fluid storage unit, the void being in fluid communication with one or more other such voids via throats. The pores, generally, have larger volumes than throats. The pores have a larger cross-sectional area than the throats, as measured perpendicular to the direction of flow. Thus, in some embodiments, the pores may be thought of as wide spots in a network of relatively more narrow flow channels (i.e., throats).

For purposes of the present disclosure, the term “cross-sectional area” refers to the characteristic area of a pore, throat, or other channel, available for flow. Cross-sectional area of a pore is measured perpendicular to the direction of flow at the flow's widest point. Cross-sectional area of a throat is measured perpendicular to the direction of flow at the flow's narrowest point. Cross-sectional area of other channels (interior channels, peripheral channels, among others) is measured perpendicular to the direction of flow.

For purposes of the present disclosure, the term “peripheral channel” refers to a channel formed in a microfluidic device which traces at least a portion of the perimeter (or circumference) of a field of pores and throats such that the field of pores and throats is at least partially bounded by the peripheral channel. The peripheral channel is connected to the field of pores and throats. In some embodiments, the cross-sectional area of the peripheral channel can be larger than those of the pores and throats. The larger cross-sectional area of the peripheral channel can be utilized to supply a sufficient amount of boundary fluid.

For purposes of the present disclosure, the term “interior channel” refers to a channel formed in a microfluidic device which traverses at least a portion of a field of pores and throats such that the interior channel has pores and throats on both sides of it. In some embodiments, the cross-sectional area of the interior channel can be larger than those of the pores and throats.

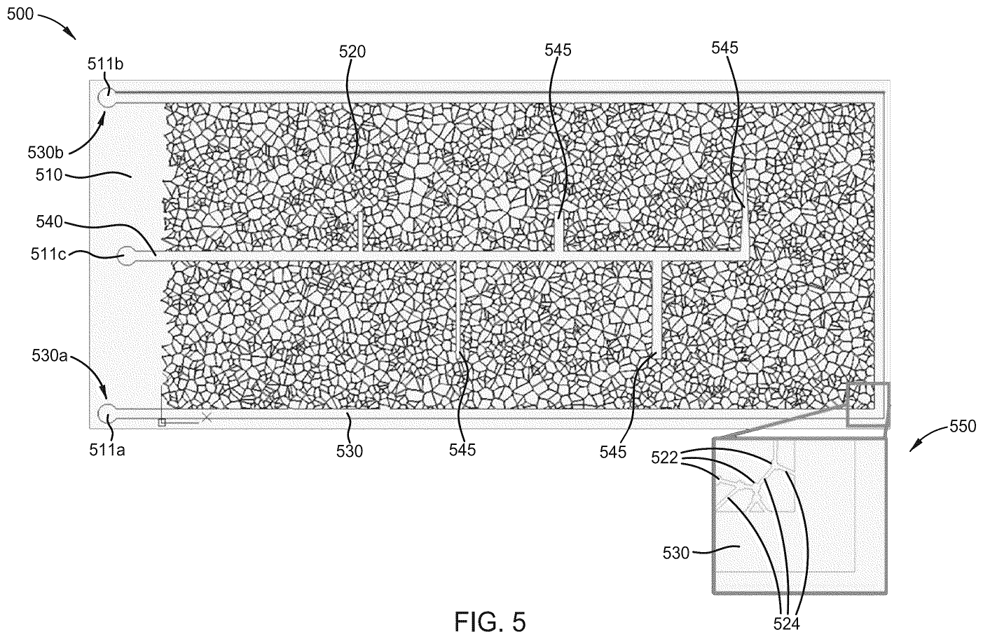

For purposes of the present disclosure, the term “side channel” refers to a channel in a microfluidic device branching off from the interior channel into the field of pores and throats representing a hydraulic-fracture segment. In some embodiments, the cross-sectional area of the side channel can be smaller than that of the interior channel. In some embodiments, the cross-sectional area of the side channel can be larger than those of the pores and throats. In some embodiments, the side channel can have a top-view triangular shape. In some embodiments, the side channel can have a top-view rectangular shape. In some embodiments, the side channel can have a top-view irregular shape. The top view is shown, for example, in FIG. 5.

For purposes of the present disclosure, the term “boundary conditions” refers to the flow and pressure settings of fluids at the boundaries of the model. In some embodiments, the boundary conditions can be constant-pressure boundaries. In some embodiments, the boundary conditions can be constant-rate, including zero rate or no flow, boundaries.

For purposes of the present disclosure, the term “infinite acting” refers to the state by which the fluids, produced at the well(s) or interior channels, behave in terms of pressure and rate when there is an infinite supply of fluids at the boundaries of the model.

For purposes of the present disclosure, the term “infinite supply” refers to the ability to inject unlimited volume of boundary fluid. In some embodiments, the supply can be hydrocarbon. In some embodiments, the supply can be water.

The use of headings is for purposes of convenience only and does not limit the scope of the present disclosure. Embodiments described herein can be combined with other embodiments.

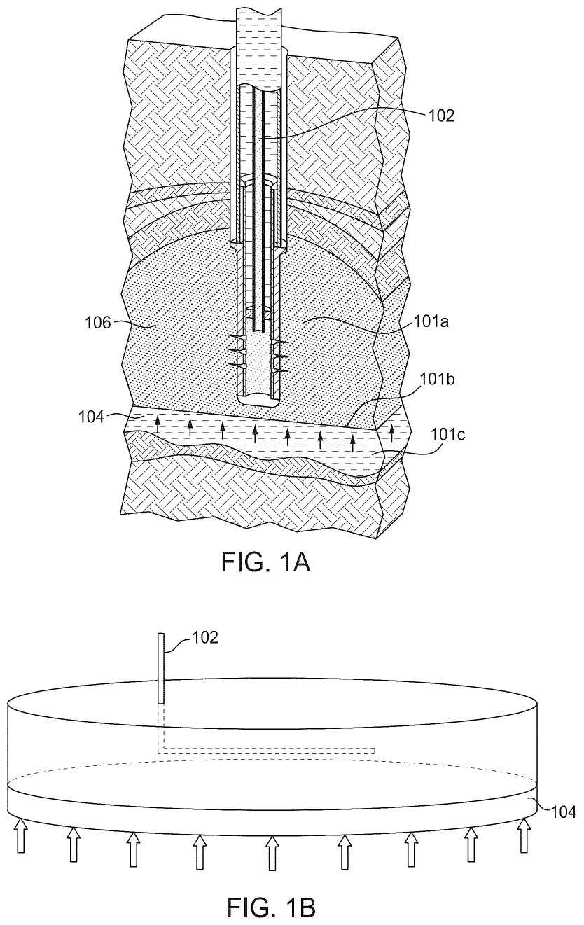

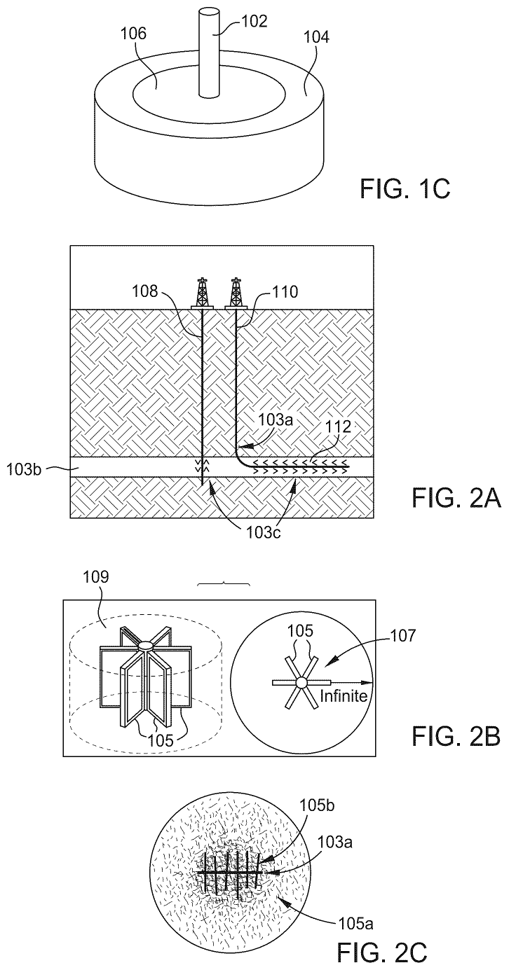

FIGS. 1A and 1B show a schematic representation of a hydrocarbon reservoir in a porous rock formation is shown. A wellbore 102 may penetrate a hydrocarbon reservoir 106 vertically and/or horizontally in order to recover at least some of the hydrocarbon fluid of the hydrocarbon reservoir 106. The hydrocarbon reservoir 106 is surrounded by a water aquifer 104, which due to its volume relative to the hydrocarbon reservoir, may be considered infinite. As fluid flows into or out of the wellbore 102, the water aquifer 104 (an infinite aquifer) may interact with the hydrocarbon reservoir and the porous rock which contains it. In FIG. 1A, 101a represents oil driven into wellbore by rising oil-water contact, 101b represents oil-water contact, and 101c represents rising water level from an active aquifer.

FIG. 1C shows a schematic representation of a layout of a water-aquifer drive. Specifically, FIG. 1C shows a vertical well drilled in a reservoir surrounded by an infinite-acting aquifer. FIG. 1C also illustrates a real-field boundary supply of fluid(s), where the supply is from almost every direction towards the point of view (which can be regarded as a producing well). The capacity of such a supply can be dictated by the drive of the reservoir. For example, and as shown in FIG. 1C, a hydrocarbon reservoir 106 (for example, oil reservoir (region 1)) surrounding a wellbore 102 can have a water aquifer 104 (region 2) at its boundaries, where the latter provides continuous supply of water that act as a pushing piston, where, the boundary behaves as a constant-rate boundary. In other words, the drive is strong enough to replace the production produced “inside” at the well by the same rate “outside” at the boundaries. A more common reservoir boundary is the constant-pressure or the no-flow reservoir boundaries. Such cases can occur when the drive of the reservoir is weak or there is no drive at the boundaries (the reservoir pressure itself is what drives the fluids to production).

FIGS. 2A-2C show a schematic representation of a traditional vertical well 108 and the more modern horizontal well 110 augmented with hydraulic fracturing 112 in the target zone. In FIG. 2A (not to scale), 103a represents a kickoff point, 103b represents a shale target zone, and 103c represents a hydraulic fracture zone. In FIG. 2B, 107 represents a fracture wing. As can be seen, the fracturing process in a well 109 may result in a series of fractures 105 that includes both natural fractures 105a and hydraulic fractures 105b comprising a complex network of pores and channels. As previously noted, the hydrocarbon reservoir contained within this complex network may be surrounded by an infinite aquifer.

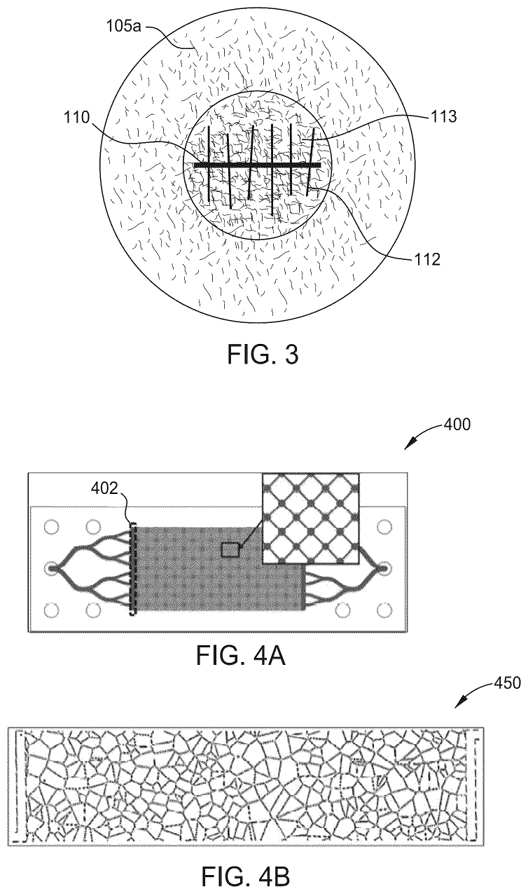

FIG. 3 shows a schematic representation of a top view of a modern horizontal well 110 augmented with hydraulic fractures 112. Due to the hydraulic-fracturing process in certain formations, a zone of microfractures 113 can surround the hydraulically-fractured wellbore. Natural fractures 105a, which may be complex, can be present as well. As previously noted, the hydrocarbon reservoir contained within this complex network can be surrounded by an infinite aquifer.

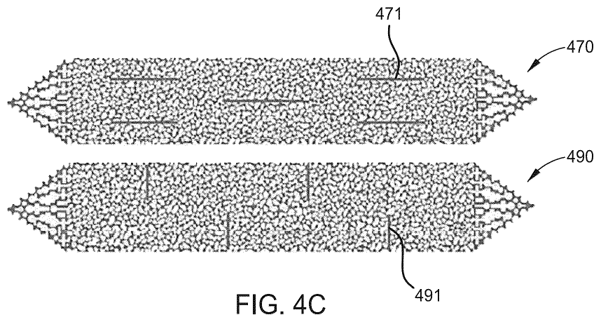

Conventional micromodels have been created in an attempt to model the complex network and the fluid flow therein. FIGS. 4A and 4B show examples of conventional micromodels 400 and 450, respectively, related to studying infinite-acting reservoirs and fractured wells

FIG. 4C shows two examples of conventional micromodels 470 and 490 related to studying naturally, not hydraulically, fractured reservoirs. In FIG. 4C, 471 and 491 refer to natural fractures oriented at different angles to the flow.

As can be seen in FIGS. 4A-4C, these conventional micromodels do not have, at least, any structures or features capable of mimicking or simulating the flow behavior of fluids at the boundary regions of real world hydrocarbon reservoirs. The conventional micromodels also lack, at least, an actual view of fractured wells. Conventional technologies also do not have the capability to freely control the shapes and dimensions of simulated fractures from the hydraulic fracturing process. Additionally, conventional micromodels do not provide the capability of including, for example, multiple channels, representing wells, under the same boundary conditions.

FIG. 5 shows an illustrative, but non-limiting, example of a micromodel 500 according to at least one embodiment of the present disclosure. FIG. 5 illustrates a top view of a horizontal well with different hydraulic fractures shapes and dimensions. The micromodel 500 can be a microfluidic device or form a portion of a microfluidic device. As further described below, the micromodel includes a peripheral channel and an interior channel, and the interior channel can be coupled to, or include, branching side channels (“hydraulic fractures”) extending into a field of pores and throats.

The micromodel 500 can be etched into a mold 510 of solid material. Formed on the surface of the mold 510 is a field 520 of pores and throats. The field 520 can simulate a rock matrix such as a porous rock formation. The field 520 can be a polygon in shape such as rectangular in shape. The field 520 of pores and throats can be laid out via a tessellation algorithm such as a Voronoi tessellation algorithm, a Delaunay tessellation algorithm, or combinations thereof, though other algorithms are contemplated. The tessellation algorithm can generate architectured structures. In some embodiments, the field 520 of pores and throats may be laid out via any other suitable geometric or randomized pattern. The pore shape (circular, square, irregular, combinations thereof, among others), size (same size, normal distribution, log-normal distribution, combinations thereof, among others), throat size (same size, normal distribution, log-normal distribution, combinations thereof, among others), and degree of angularity of pores/throats (via degree of wiggling geometry) can be adjusted as appropriate to model porous formations.

As shown in the expanded view 550 of FIG. 5, the pores 522 can be interconnected via the throats 524. In some embodiments, the pores 522 can have a larger cross-sectional area than the throats 524. In the embodiment of FIG. 5, the micromodel 500 is a “two dimensional” micromodel. For two dimensional micromodels, the pores, throats, and other channels do not vary in the z dimension (out of the paper). Thus, the area of the pores, throats, and other channels as seen from above (a top view) in FIG. 5, is characteristic of the volume of the pores, throats and other channels. Furthermore, the width of the pores, throats, and other channels as seen from above (a top view) in FIG. 5, is characteristic of the cross-sectional area perpendicular to the direction of flow of the pores, throats and other channels.

A peripheral channel 530 can be formed in the mold 510. The peripheral channel 530 can serve to mimic or simulate boundary control (for example, mimicking or simulating fluid reservoir). The peripheral channel 530 can trace at least a portion of the perimeter of the field 520 of pores 522 and throats 524. The peripheral channel 530 can trace a majority of the field 520 of pores and throats. The peripheral channel 530 can be in fluid communication with the pores 522 and the throats 524.

An interior channel 540 can be formed in the mold 510. The interior channel 540 can serve to, for example, mimic or simulate a well. The interior channel 540 can at least partially traverse the field 520 of pores 522 and the throats 524 such that the interior channel 540 can be at least partially surrounded on both sides by pores 522 and the throats 524. The interior channel 540 can have a larger cross-sectional area than the pores 522 and the throats 524.

The interior channel 540 can be in fluid communication with the field 520 of pores 522 and the throats 524. In some embodiments, the interior channel 540 can be in direct fluid communication with the field 520 of pores 522 and the throats 524. In other embodiments, the interior channel 540 is not in direct fluid communication with the field 520 of pores 522 and the throats 524. In these and other embodiments, the interior channel 540 can be in indirect fluid communication with the field 520 of pores 522 and the throats 524 via a side channel 545.

The mold 510 also includes one or more side channels 545. The one or more side channels 545 can be coupled to and can extend from the interior channel 540 into the field 520 of pores 522 and throats 524. The one or more side channels 545 can serve to mimic or simulate hydraulic fractures in a porous rock formation. As shown, the one or more side channels 545 can be of different dimensions, shapes, or combinations thereof. Additionally, or alternatively, at least two of the one or more side channels 545 can have the same dimensions, shapes, or combinations thereof.

The peripheral channel 530 can include or be coupled to fluid ports 511a, 511b at each end of the peripheral channel 530. As shown, the fluid port 511a is located at a first end 530a of the peripheral channel 530, and the fluid port 511b is located at a second end 530b of the peripheral channel 530. The fluid ports 511a, 511b can serve as a space (or void) for inserting a tubing that is connected to a fluid injection means (for example, exterior pumps, instruments, fluid reservoirs, among others). By flowing a fluid into the peripheral channel 530 via one or both fluid ports 511a, 511b, the infinite nature of real world fluid reservoirs can be simulated in the micromodel 500.

The interior channel 540 similarly includes or is coupled to a fluid port 511c. The fluid port 511c can serve as a space (or void) for inserting a tubing that is connected to a fluid injection means (for example, exterior pumps, instruments, fluid reservoirs, among others). By flowing a fluid into and/or out of the interior channel 540 via fluid port 511c, the injection of the fracturing fluid and production of hydrocarbons from a fractured horizontal well, with different shapes/dimensions of fractures, can be simulated in the micromodel 500.

In operation, and in some embodiments, tubing can be connected to one or more of fluid ports 511a, 511b, 511c. Each of the tubing is coupled to a fluid injector. A first fluid (liquid, gas, or both) is flowed through the peripheral channel 530 and enters the peripheral channel via one or both fluid ports 511a, 511b. A second fluid (liquid, gas, or both) fluid is flowed through the interior channel 540 via fluid port 511c. The second fluid can then flow into the side channels 545 and enter the field 520 of pores 522 and throats 524. The first fluid and second fluid can be the same or different. In some non-limiting examples, the first fluid, second fluid, or both can include a gas (such as natural gas, CO₂, hydrogen sulfide, a hydrocarbon (such as methane), N₂, steam, combinations thereof, among others); a liquid (such as a hydrocarbon liquid, water, brine, combinations thereof, among others); or combinations thereof. In some embodiments, the first fluid, second fluid, or both can include a surfactant, a foam, or combinations thereof. The first fluid, second fluid, or both can include an additive such as nanoparticles (for example, SiO₂), surfactant/foaming agents (for example, hexadecyl trimethyl ammonium bromide or cetrimonium bromide (CTAB)), polymer solutions (for example, xanthan gum solution), or combinations thereof, among others. The micromodel 500 can serve to, for example, model, simulate, or mimic structures and features of real world hydrocarbon reservoirs.

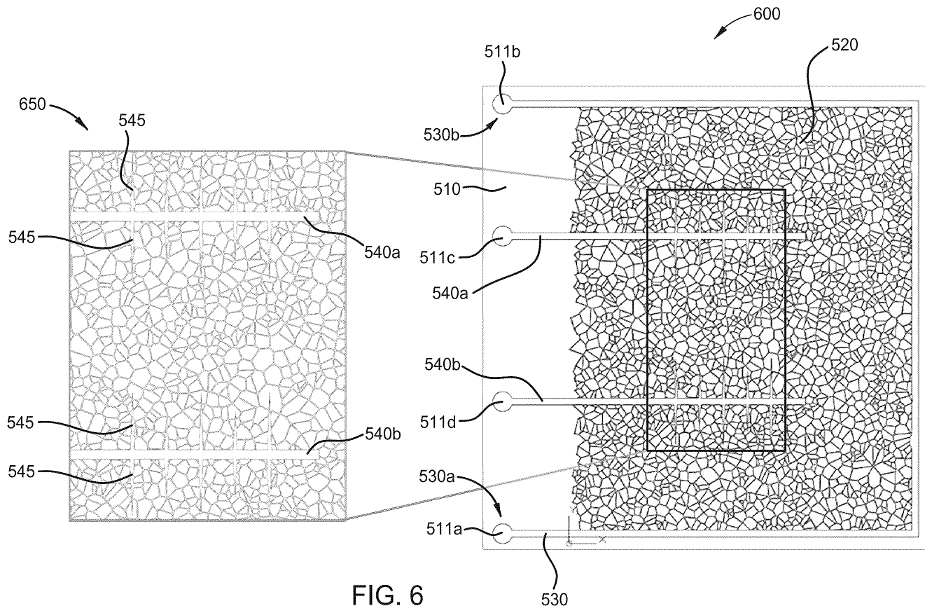

FIG. 6 shows an illustrative, but non-limiting, example of a micromodel 600 according to at least one embodiment of the present disclosure. FIG. 6 illustrates a top view of a two horizontal, fractured wells with different hydraulic fractures shapes and dimensions. The micromodel 600 can be a microfluidic device or form a portion of a microfluidic device. The micromodel 600 can be used in, for example, interference studies. Interference studies can be used to investigate the effects of different wells on one another. As described below, the micromodel 600 includes a first interior channel 540a and second interior channel 540b, which can enable such investigations. As also described below, one or both of the interior channels can be coupled to, or include, branching side channels (“hydraulic fractures”) extending into a field of pores and throats.

Although only two interior channels are shown, it is contemplated that a plurality (one or more) interior channels can be utilized such as 2, 3, 4, 5, or more interior channels.

As can be seen, the micromodel 600 is etched into a mold of solid material. A field of pores and throats is formed in the mold. As can be seen the micromodel 600 of FIG. 6 includes first interior channel 540a and second interior channel 540b. Accordingly, and in some embodiments, the effects of different wells on each other may be simulated by micromodel 600.

The micromodel 600 can be etched into a mold 510 of solid material. Formed on the surface of the mold 510 is a field 520 of pores and throats. The field 520 can simulate a rock matrix such as a porous rock formation. The field 520 can be polygon in shape such as rectangular in shape. The field 520 of pores and throats can be laid out via a tessellation algorithm such as a Voronoi tessellation algorithm, a Delaunay tessellation algorithm, or combinations thereof, though other algorithms are contemplated. The tessellation algorithm can generate architectured structures. In some embodiments, the field 520 of pores and throats may be laid out via any other suitable geometric or randomized pattern. The pore shape (circular, square, irregular, combinations thereof, among others), size (same size, normal distribution, log-normal distribution, combinations thereof, among others), throat size (same size, normal distribution, log-normal distribution, combinations thereof, among others), and degree of angularity of pores/throats (via degree of wiggling geometry) can be adjusted as appropriate to model porous formations.

As shown in the expanded view 650 of FIG. 6, the pores 522 can be interconnected via the throats 524. In some embodiments, the pores 522 can have a larger cross-sectional area than the throats 524. In the embodiment of FIG. 6, the micromodel 600 is a “two dimensional” micromodel. For two dimensional micromodels, the pores, throats, and other channels do not vary in the z dimension (out of the paper). Thus, the area of the pores, throats, and other channels as seen from above (a top view) in FIG. 6, is characteristic of the volume of the pores, throats and other channels. Furthermore, the width of the pores, throats, and other channels as seen from above (a top view) in FIG. 6, is characteristic of the cross-sectional area perpendicular to the direction of flow of the pores, throats and other channels.

A peripheral channel 530 can be formed in the mold 510. The peripheral channel 530 can serve to mimic or simulate boundary control (for example, mimicking or simulating fluid reservoir). The peripheral channel 530 can trace at least a portion of the perimeter of the field 520 of pores 522 and throats 524. The peripheral channel 530 can trace a majority of the field 520 of pores and throats. The peripheral channel 530 can be in fluid communication with the pores 522 and the throats 524.

The mold 510 of the micromodel 600 includes a first interior channel 540a and a second interior channel 540b. The first interior channel 540a and the second interior channel 540b can be formed in the mold 510. The first interior channel 540a and the second interior channel 540b can serve to, for example, mimic or simulate two wells. Although only two interior channels are shown, any suitable number of interior channels can be formed in a mold of a micromodel.

The first interior channel 540a and the second interior channel 540b can at least partially traverse the field 520 of pores 522 and the throats 524 such that the first interior channel 540a and the second interior channel 540b can be at least partially surrounded on both sides by pores 522 and the throats 524. One or more of the first interior channel 540a and the second interior channel 540b can have a larger cross-sectional area than the pores 522 and the throats 524. One or more of the first interior channel 540a and the second interior channel 540b can have a smaller cross-sectional area than the pores 522 and the throats 524.

The shape, dimensions, or both, of the first interior channel 540a and the second interior channel 540b can be the same or different. The design geometry of each well (for example, the first interior channel 540a and the second interior channel 540b) can be independent of the other well (the other interior channel) which can enable exploration of different designs.

One or more of the interior channels (for example, first interior channel 540a and/or the second interior channel 540b) can be in fluid communication with the field 520 of pores 522 and the throats 524. In some embodiments, one or more of the interior channels 540a, 540b can be in direct fluid communication with the field 520 of pores 522 and the throats 524. In other embodiments, one or more of the interior channels 540a, 540b is not in direct fluid communication with the field 520 of pores 522 and the throats 524. In these and other embodiments, one or more of the interior channels 540a, 540b can be in indirect fluid communication with the field 520 of pores 522 and the throats 524 via a side channel 545.

The mold 510 also includes one or more side channels 545. The one or more side channels 545 can be coupled to and can extend from the first interior channel 540a, the second interior channel 540b, or both, and into the field 520 of pores 522 and throats 524. The one or more side channels 545 can serve to mimic or simulate hydraulic fractures in a porous rock formation. As shown, the one or more side channels 545 can be of different dimensions, shapes, or combinations thereof. Additionally, or alternatively, at least two of the one or more side channels 545 can have the same dimensions, shapes, or combinations thereof.

The peripheral channel 530 can include or be coupled to fluid ports 511a, 511b at each end of the peripheral channel 530. As shown, the fluid port 511a is located at a first end 530a of the peripheral channel 530, and the fluid port 511b is located at a second end 530b of the peripheral channel 530. The fluid ports 511a, 511b can serve as a space (or void) for inserting a tubing that is connected to a fluid injection means (for example, exterior pumps, instruments, fluid reservoirs, among others). By flowing a fluid into the peripheral channel 530 via one or both fluid ports 511a, 511b, the infinite nature of real world fluid reservoirs can be simulated in the micromodel 600.

Each of the first interior channel 540a and the second interior channel 540b similarly includes or is coupled to fluid ports 511c, 511d, respectively. The fluid ports 511c, 511d can serve as a space (or void) for inserting a tubing that is connected to a fluid injection means (for example, exterior pumps, instruments, fluid reservoirs, among others). By flowing a fluid into one interior channel (for example, interior channel 540a via fluid port 511c) and measuring the behavior (for example, pressure, flowrate, among others) of the fluid flow from the other interior channel (for example, interior channel 540b via fluid port 511c), the interference between two fractured horizontal wells, with variable fracture properties across, can be simulated in the micromodel 600.

In operation, and in some embodiments, tubing can be connected to one or more of fluid ports 511a, 511b, 511c, 511d. Each of the tubing is coupled to a fluid injector. A first fluid (liquid, gas, or both) is flowed through the peripheral channel 530 and enters the peripheral channel via one or both fluid ports 511a, 511b. A second fluid (liquid, gas, or both) fluid is flowed through the first interior channel 540a (via fluid port 511c). Additionally, or alternatively, a third fluid (liquid, gas, or both) fluid can be flowed through the second interior channel 540b (via fluid port 511d). That is, fluid can be flowed through a single interior channel or both interior channels. The second fluid, third fluid, or both, can flow into the side channels 545 and enter the field 520 of pores 522 and throats 524. The first fluid, second fluid, and third fluid can be the same or different. In some non-limiting examples, each of the first fluid, second fluid, and third fluid can, independently, include a gas (such as natural gas, CO₂, hydrogen sulfide, a hydrocarbon (such as methane), N₂, steam, combinations thereof, among others); a liquid (such as a hydrocarbon liquid, water, brine, combinations thereof, among others); or combinations thereof. In some embodiments, each of the first fluid, second fluid, and third fluid can, independently, include a surfactant, a foam, or combinations thereof. In some embodiments, each of the first fluid, second fluid, and third fluid can, independently, include an additive such as nanoparticles (for example, SiO₂), surfactant/foaming agents (for example, hexadecyl trimethyl ammonium bromide or cetrimonium bromide (CTAB)), polymer solutions (for example, xanthan gum solution), or combinations thereof, among others. The micromodel 600 can serve to, for example, model, simulate, or mimic structures and features of real world hydrocarbon reservoirs.

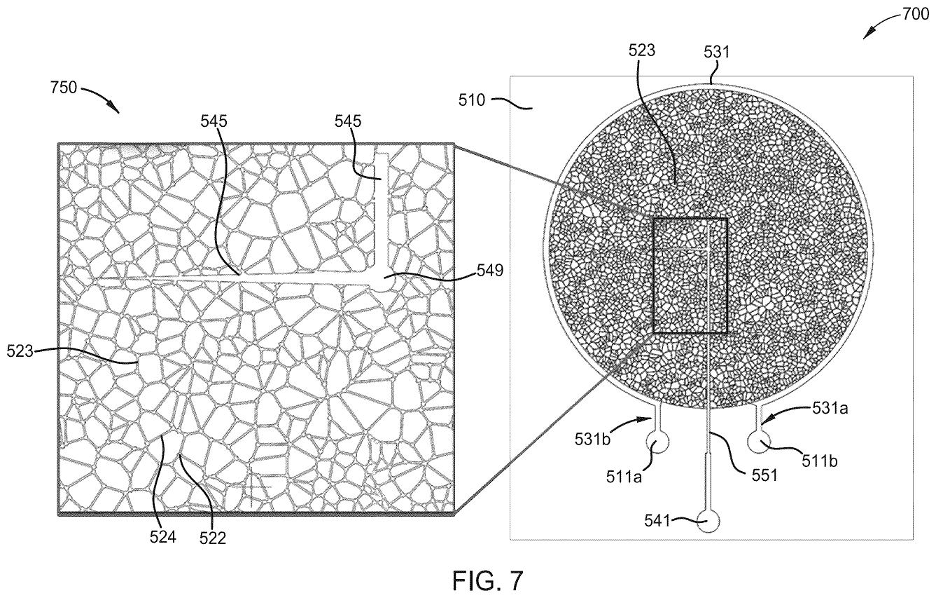

FIG. 7 shows an illustrative, but non-limiting, example of a micromodel 700 including a circular field of pores and throats according to at least one embodiment of the present disclosure. FIG. 7 illustrates a top view of a vertical well with different hydraulic fractures shapes and dimensions. The micromodel 700 can be a microfluidic device or form a portion of a microfluidic device. As further described below, the micromodel 700 includes a peripheral channel and a perpendicular-to-plane cavity, where the perpendicular-to-plane cavity can be coupled to, or include, branching side channels (“hydraulic fractures”) extending into a circular field of pores and throats.

The micromodel 700 can be etched into a mold 510 of solid material. Formed on the surface of the mold 510 is a circular field 523 of pores and throats (for example, pores 522 and throats 524 of FIG. 7). The circular field 523 can simulate a rock matrix such as a porous rock formation. The circular field 523 can be an oval shape or a circle shape. The circular field 523 of pores and throats can be laid out via a tessellation algorithm such as a Voronoi tessellation algorithm, a Delaunay tessellation algorithm, or combinations thereof, though other algorithms are contemplated. The tessellation algorithm can generate architectured structures. In some embodiments, the circular field 523 of pores and throats may be laid out via any other suitable geometric or randomized pattern. The pore shape (circular, square, irregular, combinations thereof, among others), size (same size, normal distribution, log-normal distribution, combinations thereof, among others), throat size (same size, normal distribution, log-normal distribution, combinations thereof, among others), and degree of angularity of pores/throats (via degree of wiggling geometry) can be adjusted as appropriate to model porous formations.

As shown in the expanded view 750 of FIG. 7, the pores 522 can be interconnected via the throats 524. In some embodiments, the pores 522 can have a larger cross-sectional area than the throats 524. In the embodiment of FIG. 7, the micromodel 700 is a “two dimensional” micromodel. For two dimensional micromodels, the pores, throats, and other channels do not vary in the z dimension (out of the paper). Thus, the area of the pores, throats, and other channels as seen from above (a top view) in FIG. 7, is characteristic of the volume of the pores, throats and other channels. Furthermore, the width of the pores, throats, and other channels as seen from above (a top view) in FIG. 7, is characteristic of the cross-sectional area perpendicular to the direction of flow of the pores, throats and other channels.

A peripheral channel 531 can be formed in the mold 510. Like the circular field 523, the peripheral channel is also circular in shape (or oval shape). The peripheral channel 530 can serve to mimic or simulate boundary control (for example, mimicking or simulating fluid reservoir).

The peripheral channel 531 can trace at least a portion of the perimeter of the circular field 523 of pores 522 and throats 524. In some embodiments, the peripheral channel 531 traces a majority of the perimeter of the circular field 523. For example, the peripheral channel 531 can circumscribe most of the circular field 523. The peripheral channel is also circular in shape (or oval shape). The peripheral channel 531 can be in fluid communication with the pores 522 and the throats 524.

A cavity 549 can be formed in the mold 510. The cavity 549 is perpendicular to the plane of the paper. The cavity can be referred to as a perpendicular-to-plane cavity. The cavity 549 can have a circular dimension or other suitable shape. The cavity 549 can serve to, for example, mimic or simulate a vertical wellbore.

A channel 551 can also be formed in the mold. For clarity, the expanded view 750 does not show the channel 551. The channel 551 is coupled to the cavity 549. The channel 551 is not perpendicular to the plane. The channel 551 includes is coupled to a fluid port 541 for fluid injection means (pumps, instruments, among others). The cavity 549, the channel 551, and the fluid port 541 are in fluid communication. The channel 551 can serve as a transition channel to port fluids through fluid port 541 to the cavity 549.

In some embodiments, the cavity 549 can at least partially traverse, the circular field 523 of pores 522 and the throats 524, such that the cavity 549 can be at least partially surrounded on both sides by pores 522 and the throats 524. The cavity 549 can have a larger cross-sectional area than the pores 522 and the throats 524.

In some embodiments, the channel 551 can at least partially traverse the circular field 523 of pores 522 and the throats 524 such that the channel 551 can be at least partially surrounded on both sides by pores 522 and the throats 524. The channel 551 can have a larger cross-sectional area than the pores 522 and the throats 524.

Altering the location of the fluid port 541 relative to the field of view is contemplated. For example, when the fluid port 541 is outside the field of view, the fluid injection can be performed without disrupting the imaging process. As another example, when the fluid port 541 is inside the field of view, the mold can be free of the channel 551 and fluid port 541 and cavity 549 would coincide or be the same port/cavity. In these and other embodiments, fluorescent fluids can be used for imaging.

In some embodiments, the cavity 549 can be in (direct or indirect) fluid communication with the circular field 523 of pores 522 and the throats 524. For example, and in some embodiments, the cavity 549 can be in direct fluid communication with the circular field 523 of pores 522 and the throats 524. In other embodiments, the cavity 549 is not in direct fluid communication with the circular field 523 of pores 522 and the throats 524. In these and other embodiments, the cavity 549 can be in indirect fluid communication with the circular field 523 of pores 522 and the throats 524 via one or more side channels 545.

In some embodiments, the channel 551 is not in direct fluid communication with the circular field 523 of pores 522 and the throats 524. In these and other embodiments, the channel 551 can be in indirect fluid communication with the circular field 523 of pores 522 and the throats 524 via the cavity 549 and one or more side channels 545. That is, channel 551 can serve as a bridge between the fluid port 541 and the cavity 549.

The mold 510 can also include one or more side channels 545. The one or more side channels 545 can be coupled to and can extend from the cavity 549 and into the circular field 523 of pores 522 and throats 524. The one or more side channels 545 can serve to mimic or simulate hydraulic fractures in a porous rock formation. As shown, the one or more side channels 545 can be of different dimensions, shapes, or combinations thereof. Additionally, or alternatively, at least two of the one or more side channels 545 can have the same dimensions, shapes, or combinations thereof. In some embodiments, the cavity 549 communicates between the fluid port 541 and the one or more side channels 545.

The peripheral channel 531 can include or be coupled to fluid ports 511a, 511b at each end of the peripheral channel 531. As shown, the fluid port 511a is located at a first end 531a of the peripheral channel 531, and the fluid port 511b is located at a second end 531b of the peripheral channel 531. The fluid ports 511a, 511b can serve as a space (or void) for inserting a tubing that is connected to a fluid injection means (for example, exterior pumps, instruments, fluid reservoirs, among others). By flowing a fluid into the peripheral channel 531 via one or both fluid ports 511a, 511b, the infinite nature of real world fluid reservoirs can be simulated in the micromodel 700.

Fluid port 541 can serve as a space (or void) for inserting a tubing that is connected to a fluid injection means (for example, exterior pumps, instruments, fluid reservoirs, among others). By flowing a fluid into and/or out of the cavity 549 through channel 551 via fluid port 541, the injection of the fracturing fluid and production of hydrocarbons from a vertical well can be simulated in the micromodel 700.

In operation, and in some embodiments, tubing can be connected to one or more of fluid ports 511a, 511b, 541. A first fluid (liquid, gas, or both) is flowed through the peripheral channel 531 and enters the peripheral channel via one or both fluid ports 511a, 511b. A second fluid (liquid, gas, or both) fluid is flowed through the channel 551 and to the cavity 549 via fluid port 541. The second fluid can then flow into the side channels 545 and enter the circular field 523 of pores 522 and throats 524. The first fluid and second fluid can be the same or different. In some non-limiting examples, the first fluid, second fluid, or both can include a gas (such as natural gas, CO₂, hydrogen sulfide, a hydrocarbon (such as methane), N₂, steam, combinations thereof, among others); a liquid (such as a hydrocarbon liquid, water, brine, combinations thereof, among others); or combinations thereof. In some embodiments, the first fluid, the second fluid, or both can include a surfactant, a foam, or combinations thereof. The first fluid, second fluid, or both can include an additive such as nanoparticles (for example, SiO₂), surfactant/foaming agents (for example, hexadecyl trimethyl ammonium bromide or cetrimonium bromide (CTAB)), polymer solutions (for example, xanthan gum solution), or combinations thereof, among others. The micromodel 700 can serve to, for example, model, simulate, or mimic structures and features of real world hydrocarbon reservoirs.

Circular fields can be used to, for example, provide an enhanced representation of simulating or mimicking a vertical well in certain instances. This can be due to the fact that, unlike in the case of a horizontal well, the top-view footprint of the wellbore is very small compared to the reservoir. As a result, the fluids flow radially inwards or outwards (equivalently from all directions). Having a rectangular field of pores/throats might distort such principle, where the flow from one direction, such as the direction closest to the boundary, might be stronger than the other direction. It is contemplated that circular fields can be utilized for horizontal wells. It is also contemplated that rectangular or polygonal shaped fields can be utilized for vertical wells.

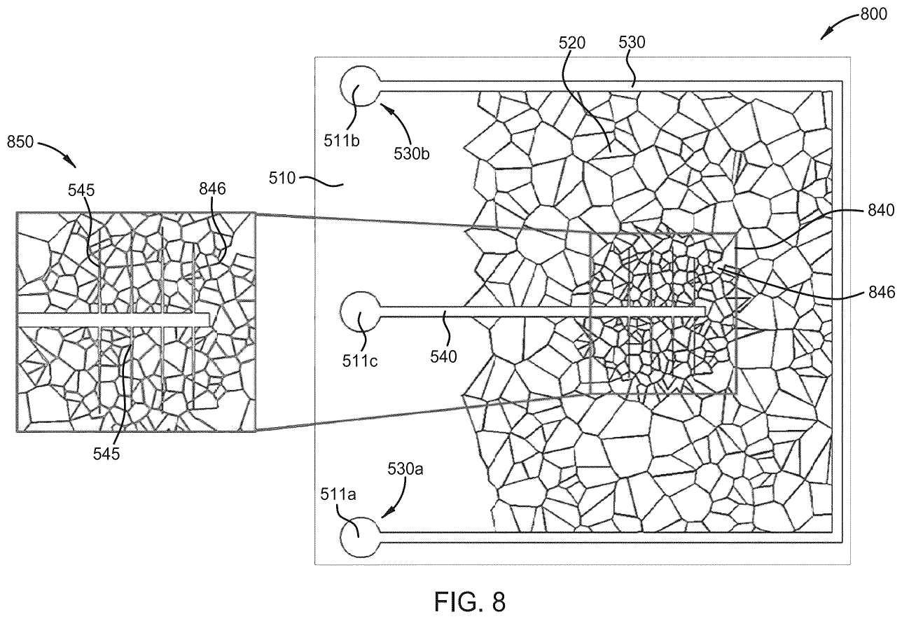

FIG. 8 shows an illustrative, but non-limiting, example of a micromodel 800 according to at least one embodiment of the present disclosure. FIG. 8 illustrates a top view of a horizontal well with hydraulic fractures and microfractures surrounding a fractured zone. The micromodel 800 can be a microfluidic device or form a portion of a microfluidic device. As further described below, the micromodel 800 includes a peripheral channel and an interior channel, and the interior channel can be coupled to, or include, branching side channels (“hydraulic fractures”) extending into a first field of pores and throats and a second field of pores and throats (“microfractures”).

The micromodel 800 can be etched into a mold 510 of solid material. Formed on the surface of the mold 510 is a first field 520 of pores and throats. The first field 520 can simulate a rock matrix such as a porous rock formation. The first field 520 can be a polygon in shape such as rectangular in shape. The first field 520 of pores and throats can be laid out via a tessellation algorithm such as a Voronoi tessellation algorithm, a Delaunay tessellation algorithm, or combinations thereof, though other algorithms are contemplated. The tessellation algorithm can generate architectured structures. In some embodiments, the first field 520 of pores and throats may be laid out via any other suitable geometric or randomized pattern. The pore shape (circular, square, irregular, combinations thereof, among others), size (same size, normal distribution, log-normal distribution, combinations thereof, among others), throat size (same size, normal distribution, log-normal distribution, combinations thereof, among others), and degree of angularity of pores/throats (via degree of wiggling geometry) can be adjusted as appropriate to model porous formations.

The pores 522 can be interconnected via the throats 524. In some embodiments, the pores 522 can have a larger cross-sectional area than the throats 524. In the embodiment of FIG. 8, the micromodel 800 is a “two dimensional” micromodel. For two dimensional micromodels, the pores, throats, and other channels do not vary in the z dimension (out of the paper). Thus, the area of the pores, throats, and other channels as seen from above (a top view) in FIG. 8, is characteristic of the volume of the pores, throats and other channels. Furthermore, the width of the pores, throats, and other channels as seen from above (a top view) in FIG. 8, is characteristic of the cross-sectional area perpendicular to the direction of flow of the pores, throats and other channels.

A peripheral channel 530 can be formed in the mold 510. The peripheral channel 530 can serve to mimic or simulate boundary control (for example, mimicking or simulating fluid reservoir). The peripheral channel 530 can trace at least a portion of the perimeter of the first field 520 of pores 522 and throats 524. The peripheral channel 530 can trace a majority of the field 520 of pores and throats. The peripheral channel 530 can be in fluid communication with the pores 522 and the throats 524.

An interior channel 540 can be formed in the mold 510. The interior channel 540 can serve to, for example, mimic or simulate a well. The interior channel 540 can at least partially traverse the first field 520 of pores 522 and the throats 524 such that the interior channel 540 can be at least partially surrounded on both sides by pores 522 and the throats 524. The interior channel 540 can be in fluid communication with the pores 522 and the throats 524. The interior channel 540 can have a larger cross-sectional area than the pores 522 and the throats 524.

The interior channel 540 can be in fluid communication with the field 520 of pores 522 and the throats 524. In some embodiments, the interior channel 540 can be in direct fluid communication with the field 520 of pores 522 and the throats 524. In other embodiments, the interior channel 540 is not in direct fluid communication with the field 520 of pores 522 and the throats 524. In these and other embodiments, the interior channel 540 can be in indirect fluid communication with the field 520 of pores 522 and the throats 524 via a side channel 545.

The mold 510 also includes one or more side channels 545. The one or more side channels 545 can be coupled to and can extend from the interior channel 540 into the first field 520 of pores 522 and throats 524. The one or more side channels 545 can serve to mimic or simulate hydraulic fractures in a porous rock formation. As shown, the one or more side channels 545 can be of different dimensions, shapes, or combinations thereof. Additionally, or alternatively, at least two of the one or more side channels 545 can have the same dimensions, shapes, or combinations thereof.

The micromodel 800 further includes a second field 840 of pores and throats (“microfractures” 846) formed on the surface of the mold 810. The microfractures 846 can surround the zone with the side channels 545 (side branches) as shown in the expanded view 850 of FIG. 8. The second field 840 can be smaller than the first field 520. The second field 840 of pores and throats can be surrounded by the first field 520 of pores and throats. The second field 840 can have a higher density of fractures (or pores and throats) than the first field 520. Alternatively, the second field 840 can have a lower density of fractures (or pores and throats) than the first field 520. The second field 840 of pores and throats can have similar characteristics as described for the first field 520 of pores and throats. In some embodiments, the pores and throats of the first field 520 are larger in size (larger in cross-sectional area) than the pores and throats of the second field 840. In at least one embodiment, the pores and throats of the second field 840 can be larger in size (larger in cross-sectional area) than those of the first field 520 (or main field) of pores and throats. In some embodiments, the second field 840 have pores and throats that connects to the first field 520 of pores and throats.

The second field 840 can simulate a rock matrix such as a porous rock formation. The second field 840 can be a polygon in shape such as rectangular in shape. The second field 840 of pores and throats can be laid out via a tessellation algorithm such as a Voronoi tessellation algorithm, a Delaunay tessellation algorithm, or combinations thereof, though other algorithms are contemplated. The tessellation algorithm can generate architectured structures. In some embodiments, the second field 840 of pores and throats may be laid out via any other suitable geometric or randomized pattern. The pore shape (circular, square, irregular, combinations thereof, among others), size (same size, normal distribution, log-normal distribution, combinations thereof, among others), throat size (same size, normal distribution, log-normal distribution, combinations thereof, among others), and degree of angularity of pores/throats (via degree of wiggling geometry) of the second field 840 can be adjusted as appropriate to model porous formations. In at least one embodiment, the mold 510 can include a second field of pores and throats around the interior channel 540 for mimicking or simulating the area of microfractures around the wellbore.

The peripheral channel 530 can include or be coupled to fluid ports 511a, 511b at each end of the peripheral channel 530. As shown, the fluid port 511a is located at a first end 530a of the peripheral channel 530, and the fluid port 511b is located at a second end 530b of the peripheral channel 530. The fluid ports 511a, 511b can serve as a space (or void) for inserting a tubing that is connected to a fluid injection means (for example, exterior pumps, instruments, fluid reservoirs, among others). By flowing a fluid into the peripheral channel 530 via one or both fluid ports 511a, 511b, the infinite nature of real world fluid reservoirs can be simulated in the micromodel 800.

The interior channel 540 similarly includes or is coupled to a fluid port 511c. The fluid port 511c can serve as a space (or void) for inserting a tubing that is connected to a fluid injection means (for example, exterior pumps, instruments, fluid reservoirs, among others). By flowing a fluid into and/or out of the interior channel 540 via fluid port 511c, the injection of the fracturing fluid and production of hydrocarbons from a fractured horizontal well, with a zone of microfractures around the wellbore, can be simulated in the micromodel 800.

In operation, and in some embodiments, tubing can be connected to one or more of fluid ports 511a, 511b, 511c. Each of the tubing is coupled to a fluid injector. A first fluid (liquid, gas, or both) is flowed through the peripheral channel 530 and enters the peripheral channel via one or both fluid ports 511a, 511b. A second fluid (liquid, gas, or both) fluid is flowed through the interior channel 540 via fluid port 511c. The second fluid can then flow into the side channels 545 and enter the first field 520 of pores 522 and throats 524 and the second field 840 of pores and throats. The first fluid and second fluid can be the same or different. In some non-limiting examples, the first fluid, second fluid, or both can include a gas (such as natural gas, CO₂, hydrogen sulfide, hydrogen sulfide, a hydrocarbon (such as methane), N₂, steam, combinations thereof, among others); a liquid (such as a hydrocarbon liquid, water, brine, combinations thereof, among others); or combinations thereof. In some embodiments, the first fluid, the second fluid, or both can include a surfactant, a foam, or combinations thereof. The first fluid, second fluid, or both can include an additive such as nanoparticles (for example, SiO₂), surfactant/foaming agents (for example, hexadecyl trimethyl ammonium bromide or cetrimonium bromide (CTAB)), polymer solutions (for example, xanthan gum solution), or combinations thereof, among others. The micromodel 800 can serve to, for example, model, simulate, or mimic structures and features of real world hydrocarbon reservoirs.

Micromodels with microfractures 846 can provide a better representation of simulating or mimicking the actual field subsurface layout in certain instances. Here, the process of hydraulic fracturing can induce a zone of microfractures around the main fractures. Such a zone majorly affects the fluid flow from the reservoir to the main fractures to the wellbore. The ability to incorporate such a feature into micromodels described herein can enable investigations of more types of field subsurface layouts.

Micromodels described herein can be, or form a portion of, a microfluidic device. Micromodels can include a mold (for example, mold 510). The mold can be etched. The etched mold mimics or simulates a porous medium, such as a porous rock formation.

In at least one embodiment, a microfluidic device to model subterranean fluid flow includes a mold of solid material, a first fluid port disposed in the device and a second fluid port disposed in the device. The mold includes a field of pores and throats formed in the mold mimicking porous rock formation. The pores formed in the mold are interconnected via the throats. The pores may have a larger cross-sectional area than the throats. The mold includes a peripheral channel formed in the mold for mimicking reservoir boundary conditions, and an interior channel formed in the mold for mimicking a well. The peripheral channel may trace a majority of a perimeter of the field of pores and throats. The peripheral channel allows fluid communication with the pores and throats. The peripheral channel may have a larger cross-sectional area than the pores and the throats. The interior channel formed in the mold may at least partially traverse the field of pores and throats. The interior channel may be in fluid communication with the pores and throats. The interior channel may have a larger cross-sectional area than the pores and the throats. The first fluid port may be in direct fluid communication with one end of the interior channel. The second fluid port may be in direct fluid communication with one end of the peripheral channel.

One or more of the peripheral channel, interior channel(s), side channel(s), pore(s), throat(s), field(s), and fluid port(s) can be in fluid communication. In some embodiments, the interior channel(s) are not in direct fluid communication with the field of pores and throats. In some embodiments, the interior channel(s) are in indirect communication with the field of pores and throats via the side channels. That is, the side channels (fractures) can connect the fluid(s) in the matrix (field of pores and throats) to the interior channel(s) (wells).

Peripheral channels described herein (for example, peripheral channel 530 or peripheral channel 531) traces at least three sides of the perimeter of a field of pores and throats (for example, field 520, circular field 523, second field 840, or combinations thereof). In at least one embodiment, the peripheral channel traces at least 50%, at least 55%, at least 60%, at least 65%, at least 70%, at least 75%, at least 80%, at least 85%, at least 90%, at least 95%, or at least 99% of a perimeter (or circumference) of a field of pores and throats (for example, field 520, circular field 523, second field 840, or combinations thereof). In at least one embodiment, the peripheral channel traces the entire perimeter (or circumference) of the field of pores and throats (for example, field 520, circular field 523, second field 840, or combinations thereof). The peripheral channel can enable micromodels described herein to more closely simulate the infinite boundary conditions of fluid reservoirs in porous rock.

Any suitable micromodel described herein can have a second field (for example, second field 840) formed in the mold (for example, mold 510). Properties of the second field are described herein.

Molds described herein (for example, mold 510) can include a side channel (for example, side channel 545) formed in the mold. Side channels described herein (for example, side channel 545) can mimic or simulate a fracture in a porous rock formation. The side channel can branch off from the interior channel into the field of pores and throats. The side channel can be in fluid communication with the interior channel.

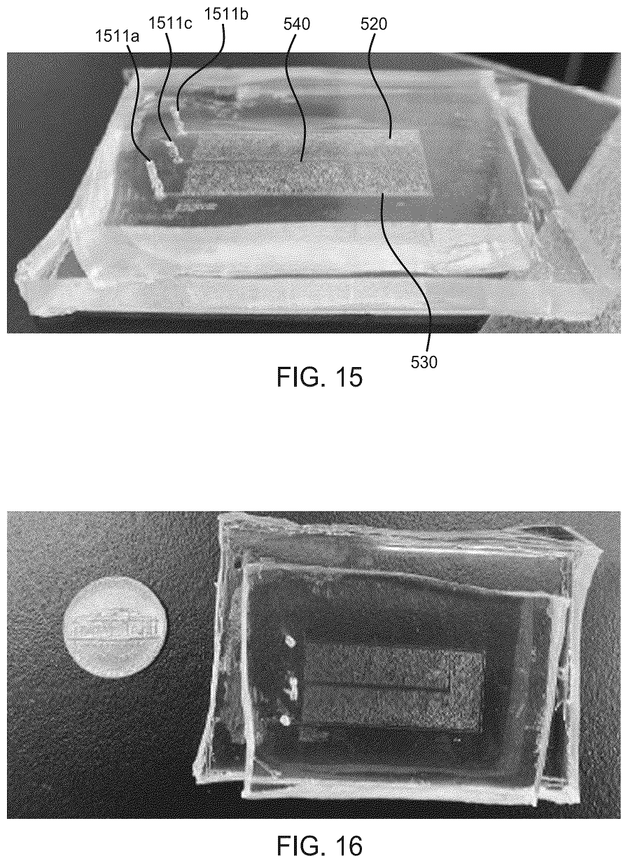

Micromodels and devices described herein can include a lid as described below with reference to FIG. 15. The lid can seal each of the throats and pores from an ambient atmosphere. The lid can be made of the same material as the mold 510. The lid can be made to cover the mold 510. Holes can be drilled into the lid to provide a fluid inlet and a fluid outlet (for example, fluid ports 511). An example is shown in FIG. 15, described below, in relation to fluid ports 1511a, 1511b, and 1511c for connection to a fluid injection means (for example, exterior pumps, instruments, fluid reservoirs, among others). Such fluid ports can be disposed in the microfluidic device. Fluid ports can be in fluid communication with an interior channel, a peripheral channel, or combinations thereof. In some embodiments, a first fluid port and a third fluid port are in fluid communication with the peripheral channel. The first fluid port can serve as an entry point for fluid to flow into the micromodel (or device) and the third fluid port can serve as an exit point for fluid to flow out of the micromodel or device. A second fluid port can be in fluid communication with an interior channel such that fluid can be flowed into the interior channel. When more than one interior channel is included in the micromodel or device thereof, each interior channel can be, independently, in fluid communication with a fluid port. The fluid ports can be in fluid communication with an end of a channel.

Molds described herein (for example, mold 510) can include one or more interior channels (for example, interior channels 540, 540a, 540b). Each interior channel can mimic or simulate a well or wellbore in a porous rock formation. In some embodiments, molds described herein (for example, mold 510) can include a first interior channel. In at least one embodiment, molds described herein can include a second interior channel.

Molds described herein (for example, mold 510) can be made or fabricated from any suitable material such as glass, a polymer, a resin, or combinations thereof. The mold can be transparent. Transparent molds can allow for light transmittance and image capturing by high-resolution cameras. In at least one embodiment, the mold can be made from polydimethylsiloxane. The lid can be made of the same or different material as the mold.

Although micromodels described herein are two-dimensional, it is contemplated that embodiments of the present disclosure can be utilized with 2.5 dimensional micromodels among others.

Dimensions of various portions of micromodels of the present disclosure are further described in the Examples section.

Embodiments described herein also relate to methods of mimicking or simulating fluid flow in a subterranean fluid system. The methods can be performed using micromodels (or devices thereof) described herein.

In some embodiments, a method of mimicking or simulating fluid flow in a subterranean fluid system may comprise or consist of one or more of the following operations: (a) mimicking or simulating a flow of a reservoir fluid; and (b) mimicking or simulating a flow of a target fluid through a well. The operation of (a) mimicking or simulating a flow of a reservoir fluid may comprise supplying a reservoir fluid to a majority of a perimeter of a field of pores and throats formed in a microfluidic device. The operation of (b) mimicking or simulating a flow of a target fluid through a well may comprise flowing a target fluid through an interior channel formed in the microfluidic device, the interior channel at least partially traversing the field of pores and throats; wherein the interior channel is in fluid communication with the pores and throats.

In some embodiments, the reservoir fluid is supplied to the perimeter of the field of pores and throats via a peripheral channel that traces a majority of the perimeter. In at least one embodiment, the reservoir fluid is supplied to both ends of the peripheral channel. In some embodiments, the reservoir fluid is supplied to the microfluidic device at a constant flow rate. In at least one embodiment, the reservoir fluid is supplied to the microfluidic device at a constant pressure. In some embodiments, the reservoir fluid comprises a hydrocarbon oil. In some embodiments, the reservoir fluid comprises water. In at least one embodiment, the target fluid comprises CO₂ for subterranean sequestration. In some embodiments, the reservoir fluid is a natural gas (for example, CH₄). In at least one embodiment, the target fluid is water. In some embodiments, the target fluid is water. In some embodiments, the target fluid is a surfactant solution. In at least one embodiment, the target fluid is a polymer solution. In some embodiments, the target fluid is N₂ with or without chemical additives.

Fluid (reservoir fluid or target fluid) flowed to the interior channel, peripheral channel, or both can include a gas (such as natural gas, CO₂, hydrogen sulfide, hydrogen sulfide, a hydrocarbon (such as methane), N₂, steam, combinations thereof, among others); a liquid (such as a hydrocarbon liquid, water, brine, combinations thereof, among others); or combinations thereof. In some embodiments, the fluid flowed (reservoir fluid or target fluid) to the interior channel, peripheral channel, or both can include a surfactant, a foam, or combinations thereof.

In some embodiments, the target fluid flows into the device through a port on the device and into the interior channel. In at least one embodiment, the target fluid flows from the interior channel through a port on the device and out of the device.

In some embodiments, the device is transparent and the method comprises visualizing the flow of the reservoir fluid and or the target fluid inside the device.

For interference studies, one or more of the operations above can be performed. Interference well testing, which is the process of measuring the pressure signal at one well while changing the rate/pressure of the other well, can be implemented using embodiments described herein. Methods for interference testing, among other methods, can include one or more of the following operations (in addition to, or as an alternative to, one or more operations described above, for example, operation (a) and/or operation (b)):
(i) In some embodiments, methods described herein can include closing a valve on one channel (for example, closing off a fluid port coupled to an interior channel) and measuring pressure in the other channel. The pressure can be measured by connecting a microfluidic pressure sensor to the flow path of the other interior channel.
(ii) In some embodiments, methods described herein can include measuring production rate by, for example, connecting a microfluidic flowmeter to the flow path of a well (interior channel). Such information can provide insight into the effects of different fracture spacing, which is the shift between the corresponding fractures in the case of two wells (two interior channels).
(iii) In some embodiments, methods described herein can include injecting a chemical one interior channel, while shutting-in the other interior channel, then allowing for both interior channels to produce. The production rates of the two wells (two interior channels) can then be measured and compared to those before the introduction of the chemical.

Systems, devices, and methods described herein can be utilized to model fluid flow in a porous medium. The systems, devices, and methods can be useful, for example, to model subterranean fluid flow. For example, and in some embodiments, systems, devices, and methods disclosed herein can be used to model the flow of hydrocarbon fluids, gases, water, among others in the underground porous reservoir formations. In some embodiments, systems, devices, and methods disclosed herein can be used to model the flow of N₂ and/or natural gases for enhanced-oil-recovery applications. The gases may or may not be accompanied by chemical additives and materials that imply interfacial property modification or hydrocarbon property/composition alteration. The chemical additives can include additives such as nanoparticles (for example, SiO₂), surfactant/foaming agents (for example, hexadecyl trimethyl ammonium bromide or cetrimonium bromide (CTAB)), polymer solutions (for example, xanthan gum solution), or combinations thereof, among others. In another embodiment, systems, devices, and methods disclosed herein can be used to model the flow of CO₂ in porous rock formations for enhanced-oil-recovery or sequestration applications. Systems, devices, and methods of the present disclosure can include structures and techniques for improved boundary-condition mimicking.

Embodiments described herein overcome the deficiencies of conventional technologies. For example, micromodels of the present disclosure can enable analysis of enhanced oil recovery mechanisms in more-realistic micromodel porous media for two and three-phase flows. Furthermore, different chemicals, wettability states, pore-size distributions, and/or fracture-matrix interactions may be tested on a more-representative matrix network micromodel. Testing different boundary conditions (rate or pressure) on the behavior of different chemicals on oil recovery from wells having single or multiple fractures (with the same or different dimensions/shapes) can be enabled. Flow-back efficiencies for using different fluid additives (simulating different fracturing fluids) at constant-rate and/or constant-pressure boundary conditions may be studied via the micromodels. Soaking-time effects on flow-back efficiency and oil recovery from a fractured model with constant-rate and/or constant-pressure boundary conditions may be studied. Investigations of fluid occupancy and saturation profiles between wells (interior channels) as well as between fractures under controlled boundary conditions are considered novel outcomes of the model experiments.

Conventional micromodels, in contrast, are not capable of mimicking or simulating the actual boundary conditions that act peripherally on wells because conventional micromodels apply conditions from one direction only. In addition, conventional micromodels are not capable of including multiple wells and studying what happens (for example, interference testing). Here, conventional micromodels are designed in such a way that multiple channels cannot be included. In order for a channel to be included, the channel has to have a mean for fluid connection or a fluid port. Conventional micromodels contain only two ports (an inlet and outlet) with the need of having the field of pores and throats in between, therefore multiple channels cannot be incorporated into conventional micromodels.

Additionally, or alternatively, the micromodels can enable the study of shape factors and fluid-transfer functions between fracture and matrix based on controlled fracture and pore and/or throat dimensions and aspect ratios. These factors can in turn be utilized as inputs for improved oil recovery (IOR) and EOR simulation studies.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used (for example, amounts, dimensions, et cetera) but some experimental errors and deviations should be accounted for.

### EXAMPLES

### Example 1: Micromodel Design

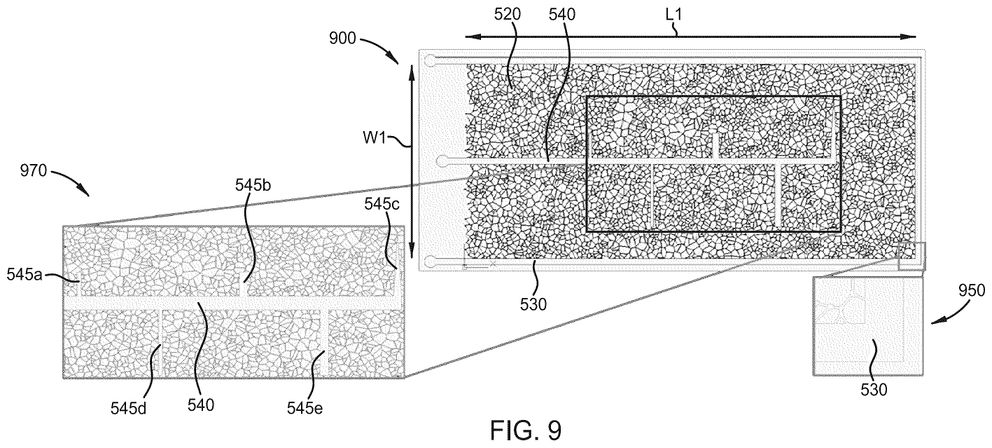

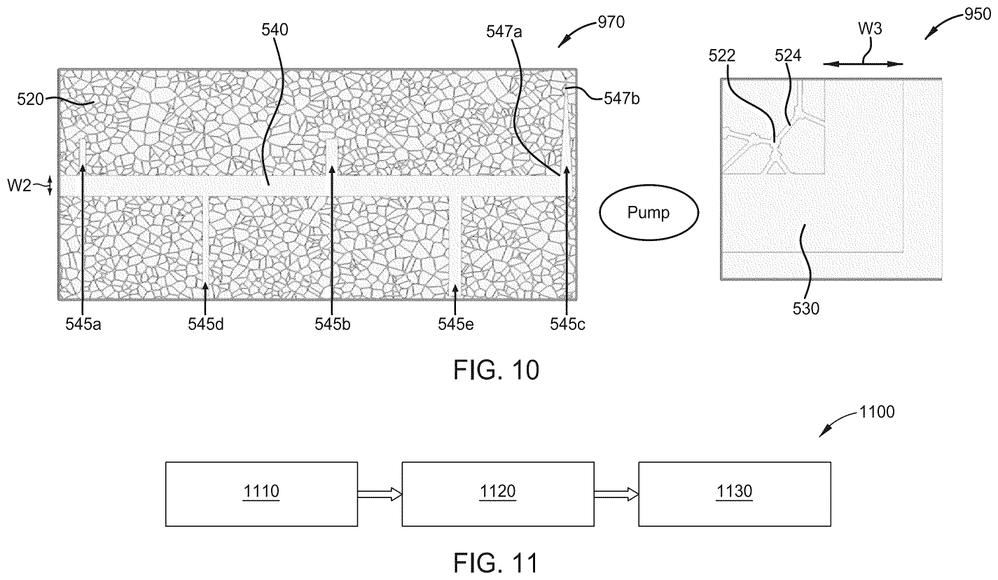

FIGS. 9 and 10 show illustrative, but non-limiting, design configurations of a micromodel 900 (for example, micromodel 500 of FIG. 5) used for a conducted study. Specifically, FIGS. 9 and 10 show the micromodel 900, expanded view 950 (showing the peripheral channel 530), and expanded view 970 (showing the interior channel 540 with side channels 545a-545e). Any suitable dimensions are contemplated.

As described herein, a field comprises pores and throats. A field of pores and throats (for example, first field 520) can have any suitable dimensions. A width (W1) of the first field 520 can be from about 1,000 μm to about 30,000 μm, such as from about 5,000 μm to about 25,000 μm, such as from about 10,000 μm to about 20,000 μm, such as from about 12,000 μm to about 18,000 μm, such as about 15,000 μm, though other values are contemplated. Any of the foregoing numbers can be used singly to describe an open-ended range or in combination to describe a close-ended range.

A length (L1) of the first field 520 can be from about 2,000 μm to about 70,000 μm, such as from about 10,000 μm to about 55,000 μm, such as from about 20,000 μm to about 45,000 μm, such as from about 30,000 μm to about 40,000 μm, such as about 35,000 μm, though other values are contemplated. Any of the foregoing numbers can be used singly to describe an open-ended range or in combination to describe a close-ended range.

Pores (for example, pores 522) of fields described herein can vary in dimension. The pores can have a cross-sectional area that is from about 10 μm to about 150 μm, such as from about 20 μm to about 140 μm, such as from about 30 μm to about 130 μm, such as from about 40 μm to about 120 μm, such as from about 50 μm to about 100 μm, such as from about 60 μm to about 90 μm, such as from about 70 μm to about 80 μm, such as about 75 μm, though other values are contemplated. Any of the foregoing numbers can be used singly to describe an open-ended range or in combination to describe a close-ended range.

Throats (for example, throats 524) of fields described herein can vary in dimension. The throats can have a cross-sectional area that is from about 5 μm to about 60 μm, such as from about 10 μm to about 50 μm, such as from about 20 μm to about 40 μm, such as from about 25 μm to about 35 μm, such as about 30 μm, though other values are contemplated. Any of the foregoing numbers can be used singly to describe an open-ended range or in combination to describe a close-ended range.

In some embodiments, pores described herein can have a larger or smaller cross-sectional area than throats described herein. In at least one embodiment, pores and throats can have the same cross-sectional area. In some embodiments, the pores can have a cross-sectional area that is about twice as large as that of the throats.

Fields described herein (for example, for example, field 520, circular field 523, second field 840, or combinations thereof) can have any suitable porosity that is less than 100% porosity. In some embodiments, a porosity of the field can about 1% or more, about 99% or less, or combinations thereof, such as from about 1% to about 75%, such as from about 2% to about 50%, such as from about 5% to about 40%, such as from about 10% to about 30%, such as from about 15% to about 25%, such as from about 15% to about 20%, such as about 16%, for example about 16.2%, or at least 3%, or at least 10%, or at least 15%, though other values are contemplated. Any of the foregoing numbers can be used singly to describe an open-ended range or in combination to describe a close-ended range.

As shown in the expanded view 970, a width (W2) of an interior channel (for example, interior channel 540) can be from about 100 μm to about 2,000 μm, such as from about 300 μm to about 1,800 μm, such as from about 500 μm to about 1,500 μm, such as from about 800 μm to about 1,200 μm, such as about 1,000 μm, though other values are contemplated. Any of the foregoing numbers can be used singly to describe an open-ended range or in combination to describe a close-ended range.

Interior channels described herein can have any suitable cross-sectional area. In at least one embodiment, the interior channel can have a cross-sectional area at least ten times larger than that of the throats. In some embodiments, the interior channel can have a cross-sectional area at least twenty times larger than that of the throats. In at least one embodiment, a ratio of the cross-sectional area of the interior channel to the cross-sectional area of the throats is from about 1.5:1 to about 50:1, such as from about 2:1 to about 40:1, such as from about 5:1 to about 30:1, such as from about 10:1 to about 20:1, though other values are contemplated. Any of the foregoing numbers can be used singly to describe an open-ended range or in combination to describe a close-ended range.

Any suitable number of side channels 545 can be utilized. In this example, five side channels 545a-545e are shown. Each side channel can have the same or different dimensions and/or shapes. One or more side channels can be tapered from the interior channel 540 to the end of the side channel (for example, as shown for side channel 545c).

A length of a side channel 545 can be from about 100 μm to about 5,000 μm, such as from about 500 μm to about 4,000 μm, such as from about 1,000 μm to about 3,500 μm, such as from about 2,000 μm to about 3,000, or about 2,000 μm, or about 5,000 μm, though other values are contemplated. Any of the foregoing numbers can be used singly to describe an open-ended range or in combination to describe a close-ended range.

A width of a side channel 545 can be from about 0.01 μm to about 1,000 μm, such as from about 10 μm to about 900 μm, such as from about 50 μm to about 800 μm, such as from about 100 μm to about 750 μm, such as from about 200 μm to about 700 μm, such as from about 300 μm to about 600 μm, such as from about 400 μm to about 500 μm, or 250 μm or 500 μm, though other values are contemplated. Any of the foregoing numbers can be used singly to describe an open-ended range or in combination to describe a close-ended range.

A width of a side channel can taper from a first side channel end 547a to a second side channel end 547b of the side channel 545. The first side channel end 547a can be directly coupled to (directly abuts or forms a face of) the interior channel 540, such that side channels are in fluid communication with an interior channel. The second side channel end 547b is an end opposite the first side channel end 547a and extends into the field 520 of pores and throats.

In one example, side channel 545a can have a width of about 250 μm and a length of about 2,000 μm; side channel 545b can have a width of about 500 μm and a length of about 2,000 μm; side channel 540d can have a width of about 250 μm and a length of about 5,000 μm; side channel 540e can have a width of about 500 μm and a length of about 5,000 μm; and side channel 545c can have a length of about 5,000 μm and a width of about 500 μm that tapers to a width of about 0 μm.

As shown in the expanded view 950, a width (W3) of a peripheral channel (for example, peripheral channel 530) can be from about 50 μm to about 1,000 μm, such as from about 100 μm to about 900 μm, such as from about 200 μm to about 800 μm, such as from about 300 μm to about 700 μm, such as from about 400 μm to about 600 μm, such as about 500 μm, though other values are contemplated. Any of the foregoing numbers can be used singly to describe an open-ended range or in combination to describe a close-ended range.

### Example 2: Imbibition Study

FIG. 11 shows a schematic diagram 1100 showing selected operations of an imbibition (flow-back) study according to at least one embodiment of the present disclosure. The stages of saturation 1110, drainage 1120, and imbibition 1130, were simulated in a micromodel. The micromodel shown in FIGS. 9 and 10 is the micromodel used for the imbibition study.

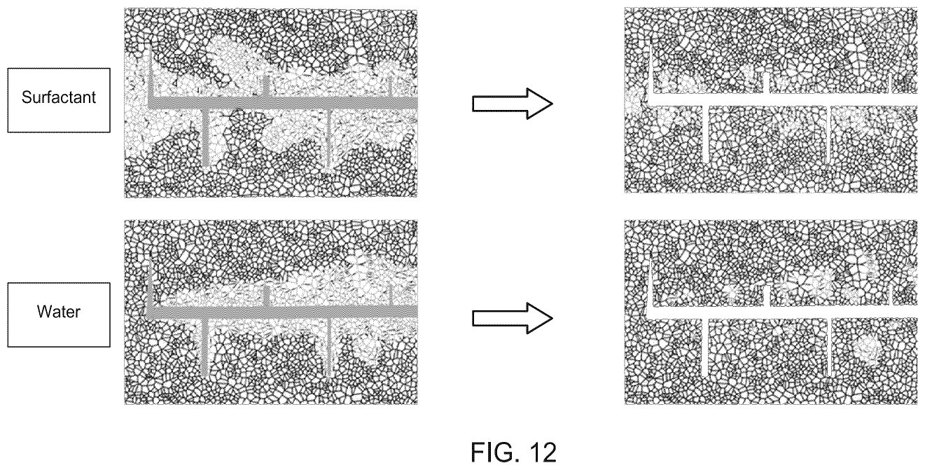

Injection of water into the simulated wellbore (for example, the interior channel) was compared to injection of surfactant. FIG. 12 shows non-limiting results of a comparison of injection of surfactant versus water after drainage (left panel, before the arrow) and after imbibition (right panel, after the arrow) according to at least one embodiment of the present disclosure. The results shown in FIG. 12 indicate that surfactant injection into the fracture produced “random” invasion into the matrix. Without wishing to be bound by theory, it is believed that this result may be due to the low interfacial tension which decreases the threshold entry capillary pressure, facilitating the invasion into more pores and throats according to the relative size difference. Water injection resulted in a more patterned matrix invasion that corresponds to the pressure gradient.

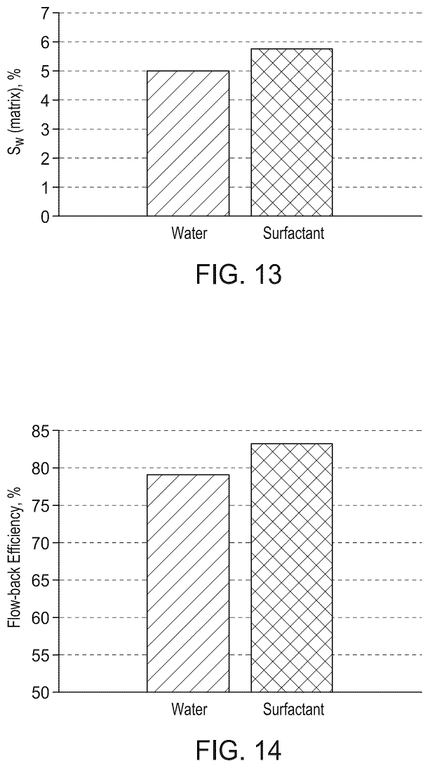

Non-limiting results of the imbibition are shown in FIGS. 13 and 14. Specifically, FIG. 13 and FIG. 14 show the final saturation and flow-back efficiency, respectively, for the comparison of water and surfactant of FIG. 12 according to at least one embodiment of the present disclosure. In FIG. 13, S_{w} (matrix) refers to the aqueous phase saturation in the field of pores and throats surrounding the interior and side channels.

Flow-back efficiency, in units of %, is determined by the following Equation (1):

$$Flow - back Efficiency ( \% ) = \frac{{S}_{w , drainage} - {S}_{w , imbibition}}{{S}_{w , drainage}} \qquad ( 1 )$$

In Equation (1), S_{w,drainage} refers to the aqueous phase saturation in the matrix after the aqueous solution (water or surfactant), simulating the fracturing fluid, has been injected. S_{w,imbibition} refers to the aqueous phase saturation in the matrix after the oil imbibition (flow-back of the fracturing fluid) to the interior channel simulating production.

The non-limiting results indicate that although the remaining water saturation after oil imbibition of the water-injection experiment was lower than that of the surfactant-injection, the flow-back efficiency of the surfactant was higher.

### Example 3: Example Micromodel

FIGS. 15 and 16 are photographs of an example micromodel according to at least one embodiment of the present disclosure. The field 520 of pores and throats, the peripheral channel 530, and the interior channel 540 are shown. Also shown are fluid ports 1511a, 1511b, and 1511c for connection to a fluid injection means (for example, exterior pumps, instruments, fluid reservoirs, among others).

### Example 4: Fabrication of Micromodel/Microfluidic Device

The micromodel can be transparent to allow for light transmittance and image capturing by high-resolution cameras. Glass, polymers, and transparent 3D-printer resins are examples of suitable materials from which a micromodel can be fabricated. In some examples, a micromodel was made using polydimethylsiloxane (PDMS) with the design shown in FIG. 5.

Voronoi tessellation using an in-house built Matlab code was utilized to produce the randomly-located field of pores and throats in the micromodel. The interior channel (well) and side channels (fractures) were integrated, using AutoCAD, into the design to produce the final layout. The micromodel design was printed onto a photomask by CAD/Art Services, Inc. After that, the PDMS model was fabricated using a soft-lithography method according to the following non-limiting procedure.

A silicon wafer was dried and de-moisturized, then thoroughly cleaned with air, then with oxygen plasma (Harrick Plasma Inc.) for about 10 minutes. Spin-coating of an epoxy negative photoresist (SU-8 2015 available from MicroChem) on the wafer at about 1,000 rpm was performed to achieve a thickness of about 150 μm. The wafer with the photoresist was soft-baked at a temperature of about 65° C. for about 1 minute and then at a temperature of about 95° C. for about 3 minutes. The wafer was then exposed to ultraviolet (UV) light with the photomask carrying the design in order to create the intended pattern of the porous medium. Post-exposure-baking was then carried out at a temperature of about 65° C. for about 1 minute then at a temperature of about 95° C. about 3 minutes. Subsequently, the wafer was allowed to cool for 5 minutes. The wafer was gently agitated in a developer solution (propylene-glycol-methyl-ether-acetate), and then cleaned using isopropanol. Following cleaning, hard-baking was performed at a temperature of about 120° C. for about 5 minutes followed by a temperature of about 150° C. for about 10 minutes. Thereupon, the wafer was allowed to cool for about 15 minutes. PDMS (Sylgard 184 silicone elastomer available from Dow Chemical Company) and a curing agent (elastomer to curing agent=10:1) were mixed and poured on the wafer contained in a petri dish. The setup was then de-gassed using a vacuum desiccator for about 30 minutes, followed by curing at a temperature of about 70° C. for about 2 hours. Another blank PDMS mold (a lid) was created to cover the etched model and enable means for fluid inlet and outlet. The cured PDMS molds were cut from the petri dishes. Inlet holes and outlet holes were poked through the blank mold. Finally, the etched and blank molds were irreversibly bonded through exposure to oxygen plasma for about 30 seconds.

### Example 5: Investigation of Different Boundary Conditions: Shapes and Dimensions of Fractures

The inclusion of a peripheral channel (for example, peripheral channel 530 or peripheral channel 531) that surrounds a majority of a field of pores and throats (for example, field 520) can enable the objective simulation of a real-field boundary supply of fluid(s), where the supply is from almost every direction towards the point of view (which can be regarded as a producing well). The capacity of such a supply can be dictated by the drive of the reservoir. For example, and as shown in FIG. 1C, a hydrocarbon reservoir 106 (for example, oil reservoir (region 1)) surrounding a wellbore 102 can have a water aquifer 104 (region 2) at its boundaries, where the latter provides continuous supply of water that act as a pushing piston, where, the boundary behaves as a constant-rate boundary. In other words, the drive is strong enough to replace the production produced “inside” at the well by the same rate “outside” at the boundaries. A more common reservoir boundary is the constant-pressure or the no-flow reservoir boundaries. Such cases can occur when the drive of the reservoir is weak or there is no drive at the boundaries (the reservoir pressure itself is what drives the fluids to production).

The testing of the aforementioned different boundaries or, more commonly and mathematically known as, boundary conditions, can be executed through controlling the manner of the supply fluid that is injected into the peripheral channel. A pump can be used to inject such a fluid into the peripheral channel of micromodels described herein. The pump can be set to operate at a constant pressure mode or at a constant rate mode. Moreover, embodiments described herein can be allowed to exclude the peripheral channel such that a no-flow boundary can be achieved.

Similarly, and as described above, hydraulic fractures within the horizontal well can have variable shapes and dimensions depending on the local stresses present at the positions of fractures as well as some operational factors. Conventional technologies shown in FIGS. 4A and 4B, and 18 do not have the capability to freely control the shapes and dimensions of simulated fractures from the hydraulic fracturing process.

In contrast, embodiments described herein have the ability to freely control the shapes and dimensions of simulated fractures from the hydraulic fracturing process. For example, the one or more side channels 545 can enable the manipulation of the shapes and dimensions of hydraulic fractures independent to the presence (if any) natural fractures. Here, there are two types of fractures: hydraulic fractures and natural fractures. Embodiments described herein contain hydraulic fractures (for example, side channels 545) having controlled shapes/dimensions. Natural fractures, which can be included in conventional micromodels (for example, as shown in FIG. 4C), can also be included in embodiments of the present disclosure. Conventional micromodels lack the ability of including hydraulic fractures as described herein.

The number of fractures can be controlled as well by including more or less side channels to the main interior channel. Such control can be useful in modeling the number of fractures (through the comparison of different models with different number of fractures) in terms of the observed production rates keeping the same boundary conditions.

### Example 6: Investigation of Wells Interference

FIG. 6, described above, shows a micromodel 600 having a two-well design with a peripheral channel for boundary control. Micromodel 600 can be utilized for interference studies which are studies that investigate the effects of different wells on one another. Conventional technologies, in contrast, cannot be used to investigate the effects of different wells on one another. Conventional micromodels are designed in such a way that multiple channels cannot be included. In order for a channel to be included, the channel has to have a mean for fluid connection or a fluid port. Conventional micromodels contain only two ports (an inlet and outlet) with the need of having the field of pores and throats in between, therefore multiple channels cannot be incorporated into conventional micromodels.

The ability to include multiple interior channels, representing multiple nearby wells, enables the use of micromodels described herein to be used for many applications including enhanced oil recovery (EOR) and well-testing applications, among others.

Investigations, using embodiments described herein, of pore-scale displacement events occurring during multiple operations between two wells, as an example, can provide improved information over conventional technologies. For example, one or more of the following (among others), can be investigated:
(a) The influence of one well on the other in terms of pressure response. Interference well testing is the process of measuring the pressure signal at one well while changing the rate/pressure of the other well. Embodiments described herein can enable, for the first time, interference testing in a laboratory setup. Such testing can provide information about the communication between wells. Here, and as described herein, embodiments of the present disclosure can enable interference because, for example, the production of each interior channel (or well) coupled with the applied boundary conditions is controlled. A simple interference test can be conducted by simply closing a valve on one channel, while measuring the pressure in the other. The pressure can be measured by connecting a microfluidic pressure sensor to the flow path of a well.
(b) The effects of different fracture spacing, which is the shift between the corresponding fractures in the two wells. Models with different fracture spacing can be compared in order to arrive at an ideal spacing relative to the production rates and the applied boundary conditions. The production rate can be measured by connecting a microfluidic flow sensor to the flow path of a well.
(c) The impact of injecting a chemical EOR agent in one well on the production of the other. A chemical can be injected in one channel, while shutting-in the other, then allowing for both channels to produce. The production rates of the two wells can be measured and compared to those before the introduction of the chemical.

Embodiments of the present disclosure generally relate to systems, devices, and methods to model fluid flow in a porous medium. As described herein, the inventors have found, at least, new and improved systems, devices, and methods that mimic or simulate actual petroleum reservoirs and conditions.

### Embodiments Listing

The present disclosure provides, among others, the following embodiments, each of which can be considered as optionally including any alternate embodiments:

Clause A1. A microfluidic device to model subterranean fluid flow, the microfluidic device comprising:
a mold of solid material, the mold comprising:
   a field of pores and throats formed in the mold, the pores are interconnected via the throats and the pores have a larger cross-sectional area than the throats;
   a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats;
   an interior channel formed in the mold, the interior channel at least partially traversing the field of pores and throats, the interior channel is in indirect fluid communication with the pores and throats, the interior channel having a larger cross-sectional area than the pores and the throats;
   a side channel formed in the mold, the side channel branching off from the interior channel into the field of pores and throats, the side channel in fluid communication with the pores and throats;
a first fluid port disposed in the microfluidic device, the first fluid port in direct fluid communication with a first end of the interior channel; and
a second fluid port disposed in the microfluidic device, the second fluid port in direct fluid communication with one end of the peripheral channel.

Clause A2. The microfluidic device of Clause A1, wherein:
the field of pores and throats is a first field of pores and throats; and
the mold further comprises a second field of pores and throats surrounding the side channel.

Clause A3. The microfluidic device of Clause A2, wherein the pores and throats of the second field have a larger cross-sectional area than the pores and throats of the first field.

Clause A4. The microfluidic device of any one of Clauses A1-A3, wherein the peripheral channel traces at least three sides of the perimeter of the field of pores and throats.

Clause A5. The microfluidic device of any one of Clauses A1-A4, wherein the peripheral channel traces at least 80% of the perimeter or the circumference of the field of pores and throats.

Clause A6. The microfluidic device of any one of Clauses A1-A5, further comprising a third fluid port disposed in the microfluidic device, the third fluid port in direct fluid communication with a second end of the peripheral channel.

Clause A7. The microfluidic device of any one of Clauses A1-A6, wherein the pores have a cross-sectional area at least twice as large as that of the throats.

Clause A8. The microfluidic device of any one of Clauses A1-A7, wherein a porosity of the field of pores and throats is at least 10% and less than 100%.

Clause A9. The microfluidic device of any one of Clauses A1-A8, wherein a porosity of the field of pores and throats is at least 15% and less than 100%.

Clause B1. A microfluidic device to model subterranean fluid flow, the microfluidic device comprising:
a mold of solid material, the mold comprising:
   a field of pores and throats formed in the mold, the pores are interconnected via the throats and the pores have a larger cross-sectional area than the throats;
   a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats;
   a plurality of interior channels formed in the mold, the plurality of interior channels at least partially traversing the field of pores and throats, the plurality of interior channels are in indirect fluid communication with the pores and throats, each interior channel of the plurality of interior channels having a larger cross-sectional area than the pores and the throats;
   at least one interior channel of the plurality of interior channels coupled to a side channel through which the at least one interior channel communicates with the field of pores and throats of the field;
a first fluid port disposed in the microfluidic device, the first fluid port in direct fluid communication with a first end of a first interior channel; and
a second fluid port disposed in the microfluidic device, the second fluid port in direct fluid communication with one end of the peripheral channel.

Clause B2. The microfluidic device of Clause B1, further comprising a third fluid port disposed in the microfluidic device, the third fluid port in direct fluid communication with a second interior channel.

Clause B3. The microfluidic device of Clause B1 or Clause B2, wherein:
the field of pores and throats is a first field of pores and throats; and
the mold further comprises a second field of pores and throats surrounding the side channel.

Clause B4. The microfluidic device of Clause B3, wherein the pores and throats of the second field have a larger cross-sectional area than the pores and throats of the first field.

Clause B5. The microfluidic device of any one of Clauses B1-B4, wherein the pores have a cross-sectional area at least twice as large as that of the throats.

Clause B6. The microfluidic device of any one of Clauses B1-B5, wherein a porosity of the field of pores and throats is at least 10% and less than 100%.

Clause C1. A method of mimicking or simulating fluid flow in a subterranean fluid system, the method comprising:
supplying a reservoir fluid to at least 50% of a perimeter or circumference of a field of pores and throats formed in a microfluidic device; and
flowing a target fluid through an interior channel formed in the microfluidic device, the interior channel at least partially traversing the field of pores and throats, the interior channel in fluid communication with the pores and throats.

Clause C2. The method of Clause C1, wherein:
the reservoir fluid is supplied to the perimeter of the field of pores and throats via a peripheral channel that traces a majority of the perimeter;
the reservoir fluid is supplied to both ends of the peripheral channel; or
combinations thereof.

Clause C3. The method of Clause C1 or Clause C2, wherein the reservoir fluid is supplied to the microfluidic device at a constant flow, a constant pressure, or combinations thereof.

Clause C4. The method of any one of Clauses C1-C3, wherein:
the reservoir fluid comprises a hydrocarbon oil;
the target fluid comprises water, CO₂, or combinations thereof; or
combinations thereof.

Clause C5. The method of any one of Clauses C1-C4, wherein the target fluid flows into the microfluidic device through a port on the microfluidic device and into the interior channel.

Clause D1. A microfluidics device to model subterranean fluid flow, the microfluidics device comprising:
a mold of solid material, wherein the mold comprises:
   a field of pores and throats formed in the mold for mimicking a porous rock formation, wherein:
      the pores are interconnected via the throats; and
      the pores have a larger cross-sectional area than the throats;
   a peripheral channel formed in the mold for mimicking a fluid reservoir, the peripheral channel tracing a majority of a perimeter of the field of pores and throats, wherein:
      the peripheral channel is in fluid communication with the pores and throats; and
      the peripheral channel has a larger cross-sectional area than the pores and the throats;
   an interior channel formed in the mold for mimicking a well, the interior channel at least partially traversing the field of pores and throats, wherein:
      the interior channel is in fluid communication with the pores and throats;
      the interior channel has a larger cross-sectional area than the pores and the throats.
   a first fluid port disposed in the microfluidics device, the first fluid port in direct fluid communication with one end of the interior channel; and
   a second fluid port disposed in the microfluidics device, the second fluid port in direct fluid communication with one end of the peripheral channel.

Clause D2. The microfluidics device of Clause D1, wherein the peripheral channel traces at least three sides of the perimeter of the field of pores and throats.

Clause D3. The microfluidics device of Clause D1 or Clause D2, wherein the peripheral channel traces at least 60% of the perimeter of the field of pores and throats.

Clause D4. The microfluidics device of any one of Clauses D1-D3, wherein the peripheral channel traces at least 80% of the perimeter of the field of pores and throats.

Clause D5. The microfluidics device of any one of Clauses D1-D4, wherein the peripheral channel traces an entire perimeter of the field of pores and throats.

Clause D6. The microfluidics device of any one of Clauses D1-D5, comprising a lid, wherein the lid seals each of the throats and pores from an ambient atmosphere.

Clause D7. The microfluidics device of any one of Clauses D1-D6, wherein the mold comprises a side channel formed in the mold for mimicking a fracture in the porous rock formation, the side channel branching off from the interior channel into the field of pores and throats.

Clause D8. The microfluidics device of any one of Clauses D1-D7, wherein the mold comprises:
a second field of pores and throats surrounding side branches of the interior channel for mimicking a microfractures zone; and
the pores and throats of the second field are larger in size than the pores and throats of a first/main field.

Clause D9. The microfluidics device of any one of Clauses D1-D8, wherein the interior channel is a first interior channel, and wherein the mold comprises at least a second interior channel for mimicking a second well in the porous rock formation.

Clause D10. The microfluidics device of any one of Clauses D1-D9, further comprising a third fluid port disposed in the microfluidics device, the third fluid port in direct fluid communication with the other end of the peripheral channel.

Clause D11. The microfluidics device of any one of Clauses D1-D10, wherein the mold is transparent.

Clause D12. The microfluidics device of any one of Clauses D1-D11, wherein the solid material comprises glass.

Clause D13. The microfluidics device of any one of Clauses D1-D12, wherein the solid material comprises a polymer.

Clause D14. The microfluidics device of any one of Clauses D1-D13, wherein the pores have a cross-sectional area at least twice as large as that of the throats.

Clause D15. The microfluidics device of any one of Clauses D1-D14, wherein the interior channel has a cross-sectional area at least ten times larger than that of the throats.

Clause D16. The microfluidics device of any one of Clauses D1-D15, wherein the interior channel has a cross-sectional area at least twenty times larger than that of the throats.

Clause D17. The microfluidics device of any one of Clauses D1-D16, wherein a porosity of the field of pores and throats is at least 10%.

Clause D18. The microfluidics device of any one of Clauses D1-D17, wherein a porosity of the field of pores and throats is at least 15%.

Clause E1. A method of mimicking fluid flow in a subterranean fluid system, the method comprising:
mimicking a flow of a reservoir fluid, comprising:
   supplying a reservoir fluid to a majority of a perimeter of a field of pores and throats formed in a microfluidics device; and
mimicking a flow of a target fluid through a well, comprising:
   flowing a target fluid through an interior channel formed in the microfluidics device, the interior channel at least partially traversing the field of pores and throats, wherein the interior channel is in fluid communication with the pores and throats.

Clause E2. The method of Clause E1, wherein the reservoir fluid is supplied to the perimeter of the field of pores and throats via a peripheral channel that traces a majority of the perimeter.

Clause E3. The method of Clause E1 or Clause E2, wherein the reservoir fluid is supplied to both ends of the peripheral channel.

Clause E4. The method of any one of Clauses E1-E3, wherein the reservoir fluid is supplied to the microfluidics device at a constant flow.

Clause E5. The method of any one of Clauses E1-E4, wherein the reservoir fluid is supplied to the microfluidics device at a constant pressure.

Clause E6. The method of any one of Clauses E1-E5, wherein the reservoir fluid comprises a hydrocarbon oil.

Clause E7. The method of any one of Clauses E1-E6, wherein the target fluid comprises water.

Clause E8. The method of any one of Clauses E1-E7, wherein the target fluid comprises CO₂ for subterranean sequestration.

Clause E9. The method of any one of Clauses E1-E8, wherein the microfluidics device is transparent, the method comprising visualizing a flow of the reservoir fluid and or the target fluid inside the microfluidics device.

Clause E10. The method of any one of Clauses E1-E9, wherein the target fluid flows into the microfluidics device through a port on the microfluidics device and into the interior channel.

Clause E11. The method of any one of Clauses E1-E10, wherein the target fluid flows from the interior channel through a port on the microfluidics device and out of the microfluidics device.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

References cited herein are incorporated by reference herein in their entirety to indicate the state of the art as of their publication or filing date and it is intended that this information can be employed herein, if needed, to exclude specific embodiments that are in the prior art.

As used herein, the indefinite article “a” or “an” shall mean “at least one” unless specified to the contrary or the context clearly indicates otherwise. For example, embodiments comprising “a channel” include embodiments comprising one, two, or more channels, unless specified to the contrary or the context clearly indicates only one channel is included.

While the foregoing is directed to embodiments of the present disclosure, other and further embodiments of the disclosure may be devised without departing from the basic scope thereof, and the scope thereof is determined by the claims that follow.

What is claimed is:

1. A microfluidic device to model subterranean fluid flow, the microfluidic device comprising:
a mold of solid material, the mold comprising:
a field of pores and throats formed in the mold, the pores are interconnected via the throats and the pores have a larger cross-sectional area than the throats;
a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats;
an interior channel formed in the mold, the interior channel at least partially traversing the field of pores and throats, the interior channel is in indirect fluid communication with the pores and throats, the interior channel having a larger cross-sectional area than the pores and the throats;
a side channel formed in the mold, the side channel branching off from the interior channel into the field of pores and throats, the side channel in fluid communication with the pores and throats;
a first fluid port disposed in the microfluidic device, the first fluid port in direct fluid communication with a first end of the interior channel; and
a second fluid port disposed in the microfluidic device, the second fluid port in direct fluid communication with one end of the peripheral channel.

2. The microfluidic device of claim 1, wherein:
the field of pores and throats is a first field of pores and throats; and
the mold further comprises a second field of pores and throats surrounding the side channel.

3. The microfluidic device of claim 2, wherein the pores and throats of the second field have a larger cross-sectional area than the pores and throats of the first field.

4. The microfluidic device of claim 1, wherein the peripheral channel traces at least three sides of the perimeter of the field of pores and throats.

5. The microfluidic device of claim 1, wherein the peripheral channel traces at least 80% of the perimeter or the circumference of the field of pores and throats.

6. The microfluidic device of claim 1, further comprising a third fluid port disposed in the microfluidic device, the third fluid port in direct fluid communication with a second end of the peripheral channel.

7. The microfluidic device of claim 1, wherein the pores have a cross-sectional area at least twice as large as that of the throats.

8. The microfluidic device of claim 1, wherein a porosity of the field of pores and throats is at least 10% and less than 100%.

9. The microfluidic device of claim 1, wherein a porosity of the field of pores and throats is at least 15% and less than 100%.

10. A microfluidic device to model subterranean fluid flow, the microfluidic device comprising:
a mold of solid material, the mold comprising:
a field of pores and throats formed in the mold, the pores are interconnected via the throats and the pores have a larger cross-sectional area than the throats;
a peripheral channel formed in the mold, the peripheral channel tracing at least 50% of a perimeter or circumference of the field of pores and throats, the peripheral channel in fluid communication with the pores and throats, the peripheral channel having a larger cross-sectional area than the pores and the throats;
a plurality of interior channels formed in the mold, the plurality of interior channels at least partially traversing the field of pores and throats, the plurality of interior channels are in indirect fluid communication with the pores and throats, each interior channel of the plurality of interior channels having a larger cross-sectional area than the pores and the throats;
at least one interior channel of the plurality of interior channels coupled to a side channel through which the at least one interior channel communicates with the field of pores and throats of the field;
a first fluid port disposed in the microfluidic device, the first fluid port in direct fluid communication with a first end of a first interior channel; and
a second fluid port disposed in the microfluidic device, the second fluid port in direct fluid communication with one end of the peripheral channel.

11. The microfluidic device of claim 10, further comprising a third fluid port disposed in the microfluidic device, the third fluid port in direct fluid communication with a second interior channel.

12. The microfluidic device of claim 10, wherein:
the field of pores and throats is a first field of pores and throats; and
the mold further comprises a second field of pores and throats surrounding the side channel.

13. The microfluidic device of claim 12, wherein the pores and throats of the second field have a larger cross-sectional area than the pores and throats of the first field.

14. The microfluidic device of claim 10, wherein the pores have a cross-sectional area at least twice as large as that of the throats.

15. The microfluidic device of claim 10, wherein a porosity of the field of pores and throats is at least 10% and less than 100%.

16. A method of mimicking or simulating fluid flow in a subterranean fluid system, the method comprising:
supplying a reservoir fluid to at least 50% of a perimeter or circumference of a field of pores and throats formed in a microfluidic device; and
flowing a target fluid through an interior channel formed in the microfluidic device, the interior channel at least partially traversing the field of pores and throats, the interior channel in fluid communication with the pores and throats.

17. The method of claim 16, wherein:
the reservoir fluid is supplied to the perimeter of the field of pores and throats via a peripheral channel that traces a majority of the perimeter;
the reservoir fluid is supplied to both ends of the peripheral channel; or
combinations thereof.

18. The method of claim 16, wherein the reservoir fluid is supplied to the microfluidic device at a constant flow, a constant pressure, or combinations thereof.

19. The method of claim 16, wherein:
the reservoir fluid comprises a hydrocarbon oil;
the target fluid comprises water, CO₂, or combinations thereof; or
combinations thereof.

20. The method of claim 16, wherein the target fluid flows into the microfluidic device through a port on the microfluidic device and into the interior channel.
